(19) United States
(12) Patent Application Publication
(10) Pub. No.: US 2026/0074930 A1
(43) Pub. Date: Mar. 12, 2026

(54) ENERGY-BASED PROBABILISTIC AMPLITUDE SHAPING

(71) Applicant: QUALCOMM Incorporated, San Diego, CA (US)

(72) Inventors: Wei LIU, Beijing (CN); Thomas Joseph RICHARDSON, South Orange, NJ (US); Liangming WU, Beijing (CN); Changlong XU, Beijing (CN); Ori SHENTAL, Marlboro, NJ (US); Hao XU, Beijing (CN)

(21) Appl. No.: 19/105,317

(22) PCT Filed: Sep. 1, 2022
(86) PCT No.: PCT/CN2022/116449

§ 371 Date: Feb. 20, 2025

(51) Int. Cl. H04L 25/03

(52) U.S. Cl. CPC H04L 25/03343; H04L 25/03178

(57) ABSTRACT

This disclosure provides methods, devices and systems for encoding data for wireless communication to achieve an amplitude distribution. One implementation includes a method in which probabilistic amplitude shaping is constrained by a maximum energy and a sequence length, and encoding iterations select energy transition values based on transition probabilities. Another implementation includes a method in which probabilistic amplitude shaping has a first step that defines a specific energy of an output sequence and uses subsequent encoding iterations to select energy transition values based on transition probabilities and within the specific energy. The methods generate output sequences defining amplitude symbols that are used to encode data for transmission.

### TECHNICAL FIELD

This disclosure relates generally to wireless communication, and more specifically, to encoding and decoding data to achieve an amplitude shaping based on energy of a transmitted or received signal.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Furthermore, as wireless communication becomes cheaper and more reliable, expectations among consumers change.

Transmitting and receiving devices may support the use of various modulation and coding schemes (MCSs) to transmit and receive data so as to optimally take advantage of wireless channel conditions, for example, to increase throughput, reduce latency, or enforce various quality of service (QoS) parameters. For example, existing technology supports the use of up to 1024-QAM and it is expected that 4096-QAM (also referred to as “4 k QAM”) will also be implemented.

As communication protocols get more complex, there is a need in the art for encoding and decoding schemes that are efficient in terms of processing, storage, and energy use.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One aspect includes a method of wireless communication, the method including: generating a plurality (k) of information bits, where k is an integer greater than 1. The method also includes performing an encoding operation on the plurality of information bits, the encoding operation having a maximum energy for amplitude modulation of the plurality of information bits, the encoding operation being performed in a plurality of iterations and including: in a first iteration, selecting a first energy transition value based at least in part on a first transition probability associated with the first energy transition value, where the maximum energy corresponds to a first interval; reducing the maximum energy by an amount associated with the first energy transition value; defining a first subinterval from the first interval, the first subinterval corresponding to the first energy transition value; in a second iteration, selecting a second energy transition value based at least in part on a second transition probability associated with the second energy transition value; and defining a second subinterval from the first subinterval, the second subinterval corresponding to the second energy transition value. The method also includes transmitting a wireless packet to at least one receiving device based on a first sequence, where the first sequence is generated from the plurality of iterations and has n amplitude symbols, where n is equal to a total quantity of the plurality of iterations, and where each of the n amplitude symbols corresponds to a respective energy transition value of a plurality of energy transition values.

Another aspect includes a wireless communication device that has at least one modem. The device also includes at least one processor communicatively coupled with the at least one modem. The device also includes at least one memory communicatively coupled with the at least one processor and storing processor-readable code that, when executed by the at least one processor in conjunction with the at least one modem, is configured to: generate a plurality (k) of information bits, where k is an integer greater than 1. The processor is also configured to perform an encoding operation on the plurality of information bits, the encoding operation having a plurality of iterations and including: determine a first cumulative sequence quantity, where the first cumulative sequence quantity defines a set of all sequences having a length n and an energy equal to or less than a first energy amount and belonging to an alphabet; perform a first function on the plurality of information bits, the first function generating a first number within a first interval; determine that the first number corresponds to a first subset of the set of all sequences; and reduce the first interval to exclude a portion of the set of all sequences outside of the first subset, thereby defining a second interval and, where the second interval corresponds to an energy for amplitude modulation of the plurality of information bits; in a first iteration, select a first energy transition value based at least in part on a first transition probability associated with the first energy transition value; reduce the energy for amplitude modulation by an amount associated with the first energy transition value; define a first subinterval from the second interval, the first subinterval corresponding to the first energy transition value; in a second iteration, select a second energy transition value based at least in part on a second transition probability associated with the second energy transition value; and define a second subinterval from the first subinterval, the second subinterval corresponding to the second energy transition value. The processor is also configured to transmit a wireless packet to at least one receiving device based on a first sequence, where the first sequence is generated from the plurality of iterations and has n amplitude symbols from the plurality of iterations, where n is equal to a total quantity of the plurality of iterations, and where each of the n amplitude symbols corresponds to a respective energy transition value of a plurality of energy transition values.

Another aspect includes a non-transitory computer-readable medium having program code recorded thereon for wireless communication by a wireless communication device. The non-transitory computer-readable medium also includes code for generating a plurality (k) of information bits, where k is an integer greater than 1; code for performing an encoding operation on the plurality of information bits, the encoding operation having a maximum energy for amplitude modulation of the plurality of information bits, the encoding operation being performed in a plurality of iterations and including: with each iteration of the plurality of iterations, selecting an amplitude symbol based upon a plurality of transition probabilities and constrained by a residual energy and a residual sequence length. The medium also includes code for transmitting a wireless packet to at least one receiving device based on the a first sequence, where the first sequence is generated from the plurality of iterations and has n amplitude symbols from the plurality of iterations, where n is equal to a quantity of the plurality of iterations.

Another aspect includes a wireless communication device configured to perform an encoding operation on a plurality (k) of information bits. The wireless communication device also includes means for determining a first energy of an output sequence, the first energy of the output sequence being between zero and a defined maximum energy; means for performing a plurality of encoding iterations, each one of the encoding iterations selecting an amplitude symbol based upon a plurality of transition probabilities and constrained by a residual energy and a residual sequence length; and means for transmitting a wireless packet to at least one receiving device based on the output sequence, where the output sequence is generated from the plurality of encoding iterations and has n amplitude symbols from the plurality of encoding iterations, where n is equal to a quantity of the plurality of encoding iterations, and where the output sequence has the first energy.

### BRIEF DESCRIPTION OF THE DRAWINGS

FIG. 1 shows a pictorial diagram of an example wireless communication network.

FIG. 2 shows a block diagram of an example wireless communication.

FIG. 3 shows a diagram of an example base station.

FIG. 4 shows a diagram of an example user equipment.

FIG. 5 shows an example transmitter chain and an example receiver chain of an architecture for probabilistic amplitude shaping (PAS).

FIGS. 6-9 shows example iterations of an energy-based encoding method.

FIGS. 10A and 10B show an example method for energy-based encoding.

FIGS. 11-15 show example iterations of an energy-based encoding method.

FIGS. 16A and 16B show an example method for energy-based encoding.

FIG. 17 is a graph-based illustration corresponding to the iterations of FIGS. 6-9.

FIG. 18 is a graph-based illustration corresponding to the iterations of FIGS. 11-15.

Like reference numbers and designations in the various drawings indicate like elements.

### DETAILED DESCRIPTION

The following description is directed to some particular implementations for the purposes of describing innovative aspects of this disclosure. However, a person having ordinary skill in the art will readily recognize that the teachings herein can be applied in a multitude of different ways. This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, Institute of Electrical and Electronics Engineers (IEEE) 802.11 standards, as well as other communications networks. As described herein, the terms “networks” and “systems” may be used interchangeably.

In current wireless communication systems, higher-order modulation (e.g., 16QAM, 64QAM and 256QAM) are used. The constellations in these systems are fixed and each constellation point is used with equal probability. Over an additive white Gaussian noise (AWGN) channel, the capacity is achievable if the input distribution is a Gaussian distribution. A difference between the signal-to-noise (SNR) to achieve a rate with a given coding and modulation scheme and the SNR at which an optimal capacity-achieving scheme could operate at the same rate is referred to as the shaping gap. For an AWGN channel, the shaping gap can be asymptotically equal to about 1.53 dB when the channel inputs are uniformly distributed. Existing techniques to reduce or close the shaping gap include geometric shaping and probabilistic shaping. Geometric shaping implements equiprobable signaling with Gaussian-like distributed constellation points. Probabilistic shaping employs equidistant constellation points and implements non-uniform (e.g., Gaussian-like) signal distribution.

Traditional approaches to probabilistic shaping include trellis shaping and shell mapping. Probabilistic amplitude shaping (PAS) is another technique to perform probabilistic shaping, and it may combine an outer layer of shaping with an inner layer of binary forward-error-correction (FEC) so that it can provide a low-complexity and flexible integration with existing bit-interleaved coded modulation (BICM) schemes. A PAS scheme may implement amplitude shifting keying (ASK) constellations and may extend to quadrature amplitude modulation (QAM) constellations by mapping two ASK symbols to one QAM symbol. PAS may provide large shaping gain and inherent rate adaptation functionality.

This disclosure provides methods, devices and systems for encoding data for wireless communication to achieve a desired amplitude distribution. An energy-based arithmetic coding (AC) encoding method may be used to perform distribution matching in a PAS scheme. An energy-based AC decoding method can be used to perform distribution de-matching in a PAS scheme. While implementations based on traditional energy-efficient shaping methods may have high computational complexity and large storage complexity, various embodiments described herein may reduce computational complexity and storage requirements.

Some implementations more specifically relate to an energy-based arithmetic coding (AC) encoding method for fixed-to-fixed distribution matching. More precisely, given a symbol alphabet, the implementation considers the set of all sequences, with elements belonging to the alphabet, such that each sequence has length equal to a target length and energy not exceeding a maximum energy. One example includes an energy-based AC encoding method that uses a number formed from the plurality of information bits to generate a symbol sequence satisfying a particular statistical property. For example, an energy-based AC encoding method may allow for determining an average empirical distribution over the symbol alphabet that is close to a target amplitude distribution, e.g., a Gaussian like distribution or a Maxwell-Boltzmann distribution. The implementation may further include an energy-based AC decoding method.

Another example includes a two-step energy-based AC encoding method for fixed-to-fixed distribution matching. More precisely, given a symbol alphabet, the implementation may consider the set of all sequences, with elements belonging to the alphabet, such that each sequence has length equal to a target length and energy not exceeding a maximum energy. One proposal is a two-step energy-based AC encoding method that uses a number formed from the plurality of information bits to generate a symbol sequence using a two-step energy-based AC encoding method. In the first step, an energy equal to or less than a first energy amount is selected, while in the second step, a symbol sequence is generated according to the selected energy. Overall, the two-step energy-based AC encoding method may allow for determining an average empirical distribution over the symbol alphabet that is close to a target amplitude distribution, e.g., a Gaussian like distribution or a Maxwell-Boltzmann distribution. Based on the two-step energy-based AC encoding method, the implementation may further include a two-step energy-based AC decoding method.

Various implementations can be viewed as an efficient method to realize distribution matching and dematching. Moreover, the various implementations may be more energy efficient by limiting symbol sequences to a maximum energy.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The κG NR will be capable of scaling to provide coverage (1) to a massive Internet of things (IoTs) with a ULtra-high density (e.g., ˜1M nodes/km²), ultra-low complexity (e.g., ˜10s of bits/sec), ultra-low energy (e.g., ˜10+γears of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof, and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR system may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW. In certain aspects, frequency bands for 5G NR are separated into two different frequency ranges, a frequency range one (FR1) and a frequency range two (FR2). FR1 bands include frequency bands at 7 GHz or lower (e.g., between about 410 MHz to about 7125 MHz). FR2 bands include frequency bands in mmWave ranges between about 24.25 GHz and about 52.6 GHz. The mmWave bands may have a shorter range, but a higher bandwidth than the FR1 bands. Additionally, 5G NR may support different sets of subcarrier spacing for different frequency ranges.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

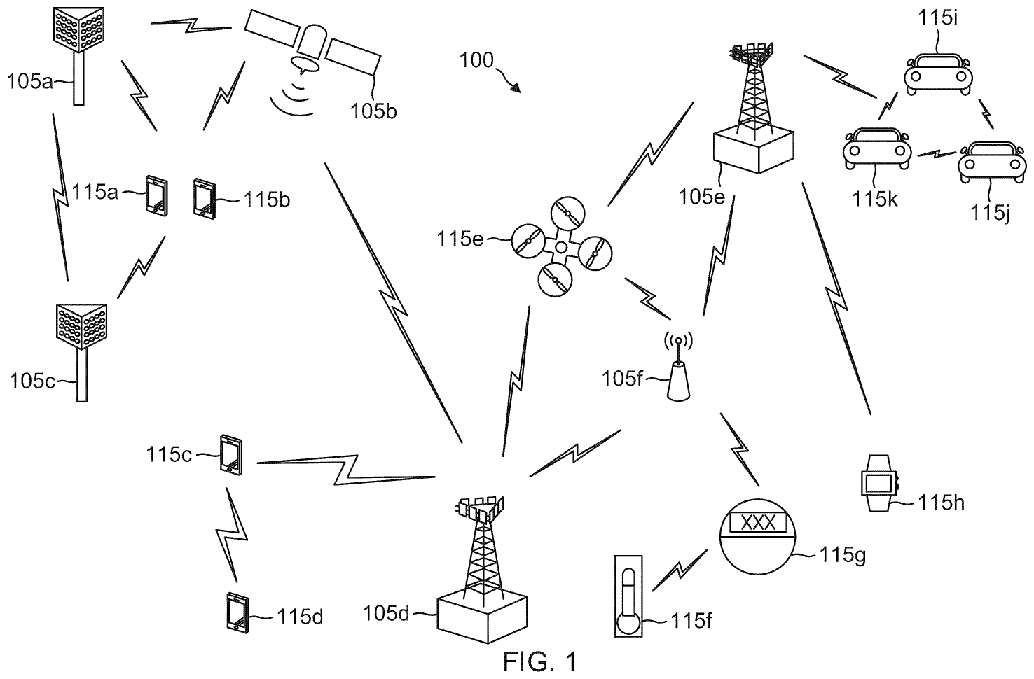

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 (individually labeled as 115a, 115b, 115c, 115d, 115e, 115f, 115g, 115h, and 115k) and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each ULE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support communications with ultra-reliable and redundant links for devices, such as the UE 115e, which may be airborne. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-action-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some aspects, the subcarrier spacing between adjacent subcarriers may be fixed, and the total number of subcarriers (K) may be dependent on the system BW. The system BW may also be partitioned into subbands. In other aspects, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some aspects, the BSs 105 may broadcast the PSS, the SSS, and/or the MIB in the form of SSBs and may broadcast the RMSI and/or the OSI over a physical downlink shared channel (PDSCH). The MIB may be transmitted over a physical broadcast channel (PBCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant. The connection may be referred to as an RRC connection. When the UE 115 is actively exchanging data with the BS 105, the UE 115 is in an RRC connected state.

In an example, after establishing a connection with the BS 105, the UE 115 may initiate an initial network attachment procedure with the network 100. The BS 105 may coordinate with various network entities or fifth generation core (5GC) entities, such as an access and mobility function (AMF), a serving gateway (SGW), and/or a packet data network gateway (PGW), to complete the network attachment procedure.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The BS 105 and the UE 115 may also apply HARQ for UL communications using substantially similar mechanisms as the DL HARQ.

In some aspects, a UE 115 and a BS 105 may be capable of encoding and decoding information according to the energy-based arithmetic coding methods described herein.

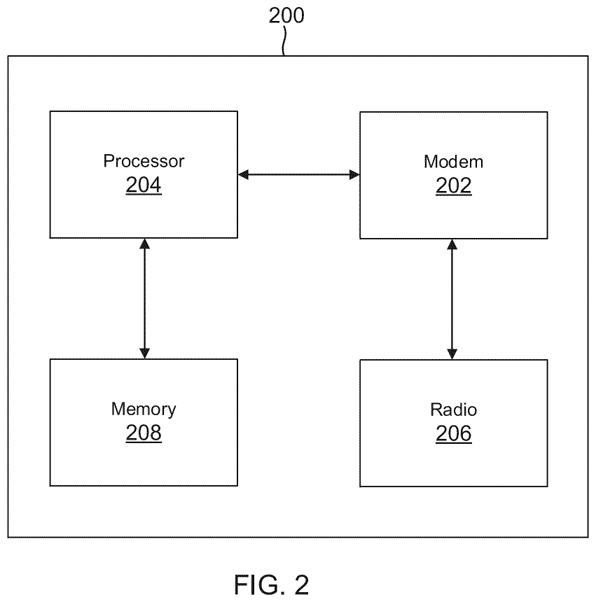

FIG. 2 shows a block diagram of an example wireless communication device 200. In some implementations, the wireless communication device 200 can be an example of a device for use in a UE such as one of the UEs 115 described above with reference to FIG. 1. In some implementations, the wireless communication device 200 can be an example of a device for use in a BS such as the BSs 105 described above with reference to FIG. 1. The wireless communication device 200 is capable of transmitting and receiving wireless communications in the form of, for example, wireless packets.

The wireless communication device 200 can be, or can include, a chip, system on chip (SoC), chipset, package or device that includes one or more modems 202, for example, a 3GPP 4G LTE or 5G compliant modem. In some implementations, the one or more modems 202 (collectively “the modem 202”) additionally include a Wi-Fi (IEEE 802.11 compliant) modem. In some implementations, the wireless communication device 200 also includes one or more processors, processing blocks or processing elements 204 (collectively “the processor 204”) coupled with the modem 202. In some implementations, the wireless communication device 200 additionally includes one or more radios 206 (collectively “the radio 206”) coupled with the modem 202. In some implementations, the wireless communication device 200 further includes one or more memory blocks or elements 208 (collectively “the memory 208”) coupled with the processor 204 or the modem 202.

The modem 202 can include an intelligent hardware block or device such as, for example, an application-specific integrated circuit (ASIC), among other examples. The modem 202 is generally configured to implement a PHY layer, and in some implementations, also a portion of a MAC layer (for example, a hardware portion of the MAC layer). For example, the modem 202 is configured to modulate packets and to output the modulated packets to the radio 206 for transmission over the wireless medium. The modem 202 is similarly configured to obtain modulated packets received by the radio 206 and to demodulate the packets to provide demodulated packets. In addition to a modulator and a demodulator, the modem 202 may further include digital signal processing (DSP) circuitry, automatic gain control (AGC) circuitry, a coder, a decoder, a multiplexer and a demultiplexer. For example, while in a transmission mode, data obtained from the processor 204 may be provided to an encoder, which encodes the data to provide coded bits. The coded bits may then be mapped to a number Nss of spatial streams for spatial multiplexing or a number Nsrs of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 206. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 206, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be provided to the MAC layer (the processor 204) for processing, evaluation or interpretation.

The radio 206 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 200 can include, or be coupled with, multiple transmit antennas (each with a corresponding transmit chain) and multiple receive antennas (each with a corresponding receive chain). The symbols output from the modem 202 are provided to the radio 206, which then transmits the symbols via the coupled antennas. Similarly, symbols received via the antennas are obtained by the radio 206, which then provides the symbols to the modem 202.

The processor 204 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 204 processes information received through the radio 206 and the modem 202, and processes information to be output through the modem 202 and the radio 206 for transmission through the wireless medium. For example, the processor 204 may implement a control plane and at least a portion of a MAC layer configured to perform various operations related to the generation, transmission, reception and processing of packets. In some implementations, the MAC layer is configured to generate packets for provision to the PHY layer for coding, and to receive decoded information bits from the PHY layer for processing as packets. The MAC layer may further be configured to allocate time and frequency resources, for example, for OFDMA, among other operations or techniques. In some implementations, the processor 204 may generally control the modem 202 to cause the modem to perform various operations described above.

The memory 208 can include tangible storage media such as random-access memory (RAM) or read-only memory (ROM), or combinations thereof. The memory 208 also can store non-transitory processor- or computer-executable software (SW) code containing instructions that, when executed by the processor 204, cause the processor to perform various operations described herein for wireless communication, including the generation, transmission, reception and interpretation of frames or packets. For example, various functions of components disclosed herein, or various blocks or steps of a method, operation, process or algorithm disclosed herein, can be implemented as one or more modules of one or more computer programs.

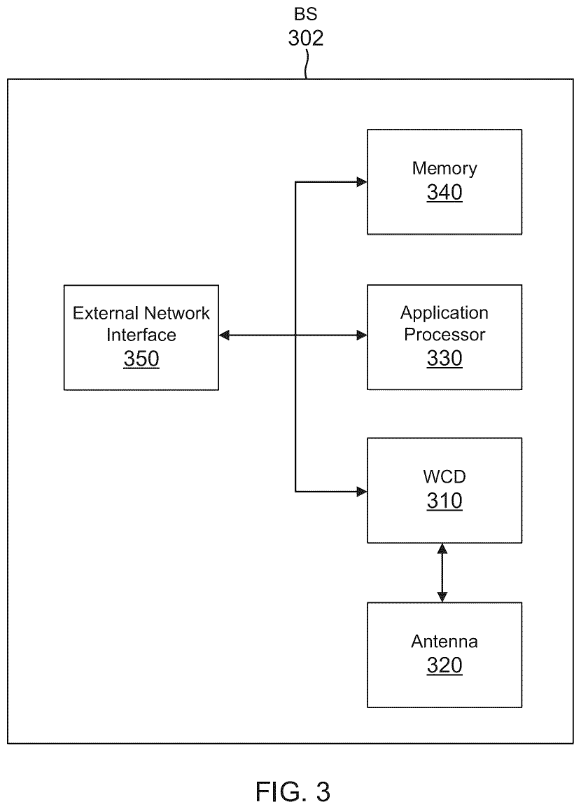

FIG. 3 shows a block diagram of an example BS 302. For example, the BS 302 can be an example implementation of the BS 105 described with reference to FIG. 1. The BS 302 includes a wireless communication device (WCD) 310 (although the BS 302 may itself also be referred to generally as a wireless communication device as used herein). For example, the wireless communication device 310 may be an example implementation of the wireless communication device 200 described with reference to FIG. 2. The BS 302 also includes multiple antennas 320 coupled with the wireless communication device 310 to transmit and receive wireless communications. In some implementations, the BS 302 additionally includes an application processor 330 coupled with the wireless communication device 310, and a memory 340 coupled with the application processor 330. The BS 302 further includes at least one external network interface 350 that enables the BS 302 to communicate with a core network or backhaul network to gain access to external networks including the Internet. For example, the external network interface 350 may include one or both of a wired (for example, Ethernet) network interface and a wireless network interface. Ones of the aforementioned components can communicate with other ones of the components directly or indirectly, over at least one bus. The BS 302 further includes a housing that encompasses the wireless communication device 310, the application processor 330, the memory 340, and at least portions of the antennas 320 and external network interface 350.

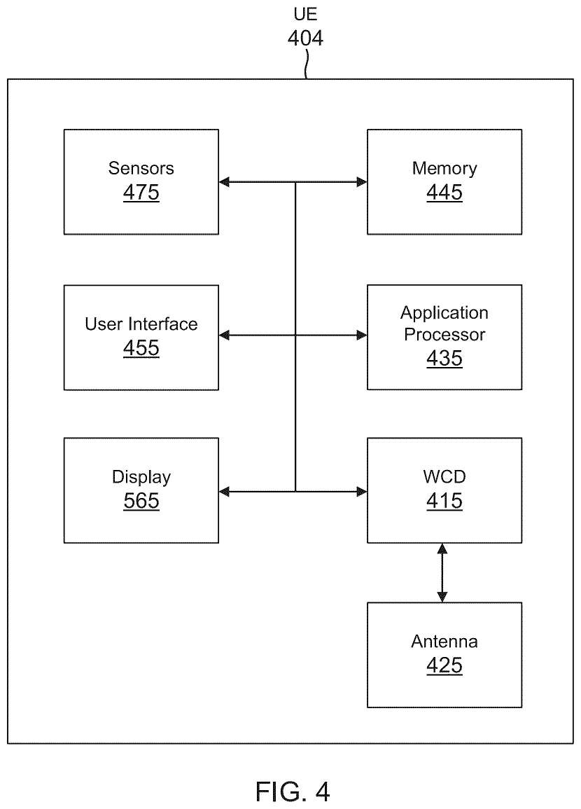

FIG. 4 shows a block diagram of an example UE 304. For example, the UE 304 can be an example implementation of the UE 115 described with reference to FIG. 1. The UE 304 includes a wireless communication device 415 (although the UE 304 may itself also be referred to generally as a wireless communication device as used herein). For example, the wireless communication device 415 may be an example implementation of the wireless communication device 200 described with reference to FIG. 2. The UE 304 also includes one or more antennas 425 coupled with the wireless communication device 415 to transmit and receive wireless communications. The UE 304 additionally includes an application processor 435 coupled with the wireless communication device 415, and a memory 445 coupled with the application processor 435. In some implementations, the UE 304 further includes a user interface (UI) 455 (such as a touchscreen or keypad) and a display 465, which may be integrated with the UI 455 to form a touchscreen display. In some implementations, the UE 304 may further include one or more sensors 475 such as, for example, one or more inertial sensors, accelerometers, temperature sensors, pressure sensors, or altitude sensors. Ones of the aforementioned components can communicate with other ones of the components directly or indirectly, over at least one bus. The UE 304 further includes a housing that encompasses the wireless communication device 415, the application processor 435, the memory 445, and at least portions of the antennas 425, UI 455, and display 465.

### General Context for Probabilistic Amplitude Shaping

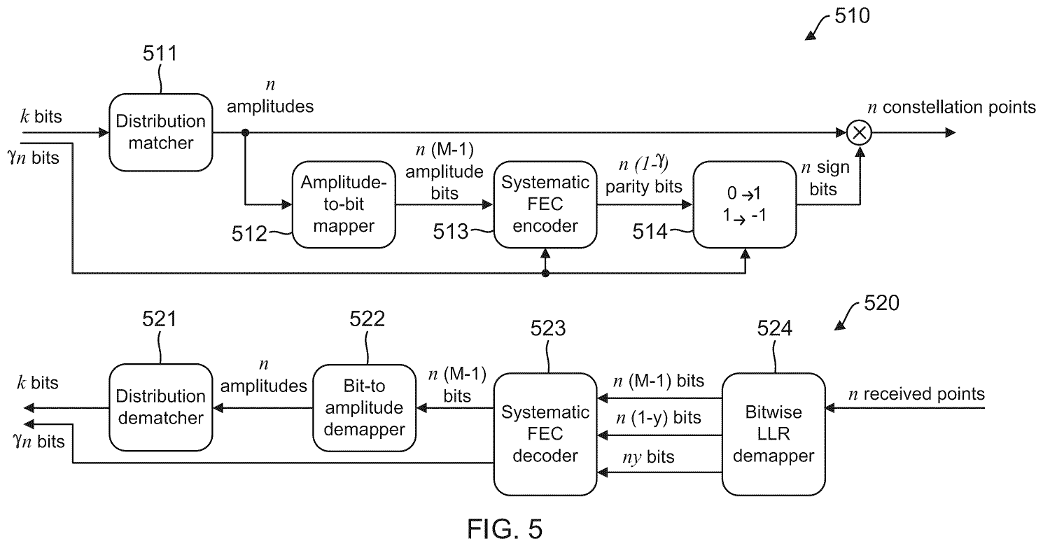

FIG. 5 illustrates an example transmitter chain 510 and an example receiver chain 520 of an architecture for probabilistic amplitude shaping (PAS), according to one implementation. For instance, the transmitter chain 510 and the receiver chain 520 may be implemented within the wireless communication device 200 of FIG. 2. The transmitter chain 510 includes a distribution matcher 511 as well as a forward-error-correction (FEC) chain having mapper 512, FEC encoder 513, and sign module 514. The two energy-based AC methods (the one-step and the two-step) discussed herein may be implemented by a device conforming to the architecture of FIG. 5, though the scope of implementation is not limited to that architecture. Encoding methods disclosed herein can be used to perform a distribution matching task (e.g., at the distribution matcher 511) in that system, and decoding methods disclosed herein can be used to perform a distribution dematching task (e.g., at the distribution dematcher 521).

The receiver chain 520 includes a distribution de-matcher 521, a de-mapper 522, FEC decoder 523, and bitwise logarithm likelihood ratio (LLR) de-mapper 524. The example of FIG. 5 uses 2^{M}-ary amplitude shifting keying (ASK) constellation {±1, ±3, . . . , ±(2^{M}−1)} with amplitude alphabet [symbol] ={1, 3, . . . , 2^{M}−1}. The n(M−1) amplitude bits and the γn information bits together constitute the n(M−1+γ) bits as input to the systematic FEC encoder 513, which then generates n(1−γ) parity bits. The n(1−γ) parity bits together with the γn information bits are converted to n sign bits and are pointwise multiplied with the n amplitudes from the output of the distribution matcher 511. The distribution matching (DM) rate is R_{dm}=k/n, the systematic forward-error-correction (FEC) code rate is R_{c}=(M−1+γ)/M, and the transmission rate is Rt=R_{dm}+γ, where γn is a number of additional information bits added for FEC.

The present example uses a fixed-to-fixed DM at the distribution matcher 511 to map a length-k bit sequence to a length-n amplitude sequence, and it induces a non-uniform marginal distribution over the amplitude symbols {1, 3, . . . , 2^{M}−1}. The k bits are typically assumed to be independent and identically distributed (i.i.d.) with the uniform distribution. However, the non-uniform distribution over the amplitude symbols is expected to be closer to the capacity-achieving distribution than the uniform one, e.g., being more Gaussian-like or being a Maxwell-Boltzmann (MB) distribution in the AWGN setting.

### Symbol Terminologies and Nomenclatures

Before getting into examples of arithmetic coding being performed, it is instructive to look at mathematical functions that may be applied to data for the purpose of transmitting and receiving encoded data.

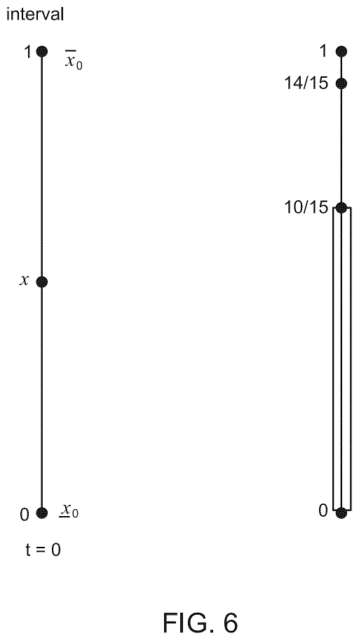

The following paragraphs introduce concepts that underpin the AC encoding and decoding methods described with respect to FIGS. 6-18. For example, an alphabet may define possible energy transition values. In these examples, the alphabet is given a symbolic notation, [symbol] ₘ.

For example, if m>1 is an integer, then [symbol] ₘ {a₁, a₂, . . . , aₘ} is a symbol alphabet of size m. Examples impose an ordering< on the alphabet [symbol] ₘ such that aᵢ< aᵢ₊1 for each i, i.e., a₁< a₂< . . . < aₘ.

Energy of a symbol is another concept within the embodiments described herein. For instance, each different symbol may correspond to a different energy. Given an alphabet [symbol] ₘ of size m, examples denote by E(aᵢ) the energy of symbol a₁ for each i. In this example, symbol energies may take distinct values and may be assumed for any i ∈{1, 2, . . . , m−1} that the following relation holds true:

$$0 \leq E ( {a}_{i} ) < E ( {a}_{i + 1} ) . \qquad ( 1 )$$

One example of symbol energy includes ASK constellations. In such cases, examples may take [symbol] ₘ={1, 3, . . . , 2^{M}−1} so that m=2^{M-1} and {-1, 1}× [symbol] ₘ corresponds to a 2^{M}-ary ASK alphabet so that m depends on a modulation order. In such an example, aᵢ=2i−1 so that a₁=1, a₂=3, . . . , aₘ=2^{M}−1. There is a squared relationship between a symbol and its corresponding energy, as in Examples 1, 2 below:

Example 1: for each i, the energy Ē (aᵢ) of symbol aᵢ satisfies:

$$E ( {a}_{i} ) = {( 2 i - 1 )}^{2} . \qquad ( 2 )$$

Example 2: for each i, the energy Ē (aᵢ) of symbol aᵢ satisfies:

$$E ( {a}_{i} ) = \frac{i ( i - 1 )}{2} . \qquad ( 3 )$$

There is relation between E(aᵢ) in Example 1 and E(aᵢ) in Example 2. Specifically, if 8i(i−1)/2+1=(2i−1)², then E(aᵢ) in Example 2 only involves a rescaling of E(aᵢ) in Example 1. Put another way, 8 times E(aᵢ) in Example 2 plus 1 is equal to E(aᵢ) in Example 1.

As noted above, a given symbol aᵢ corresponds to an energy transition value E(aᵢ). Therefore, a sequence of symbols also corresponds to an energy. Given an alphabet [symbol] ₘ of size m, there is a sequence, s=(s₁, s₂, . . . , sₙ), each element of which takes values in [symbol] ₘ. The energy of the sequence s, denoted by E(s), may be defined as the accumulation, i.e., summation, of all symbol energies of symbols belong to the sequence s. For example, the energy Ē (s) of the sequence s may be determined in accordance with the following Equation (4):

$$E ( s ) = {\sum }_{l = 1}^{′ t} E ( {s}_{l} ) . \qquad ( 4 )$$

Examples may denote by

$${s}_{1}^{t}$$

the prefix (s₁, s₂, . . . , sₜ) of s so that the sequence s is also denoted by

$${s}_{1}^{n} .$$

The energy of the prefix

$${s}_{1}^{t} is E ( {s}_{1}^{t} ) = {Σ}_{l = 1}^{t} E ( {s}_{l} ) .$$

The examples herein denote a cardinality of all sequences having an energy E and a length n as N(n, E). E and n are nonnegative integers. The total number of sequences over [symbol] ₘ having length n and energy Ē is denoted by N^{[m]}(n, E). When the underlying size m is clear from the context, N(n, E) can be used as a proxy.

The examples herein may refer to “sequences over [symbol] ₘ and having length n”, and by “over [symbol] ₘ” examples mean each element (i.e., symbol) of an involved sequence belongs to [symbol] ₘ.

The examples herein denote a cardinality of all sequences having an energy E and below and a length n as N_{c}(n, E).

As noted above, [symbol] ₘ={a₁, a₂, . . . , aₘ} is a finite symbol alphabet of size m, and symbol aᵢ has energy Ē (aᵢ). The number

$${N}_{c}^{[ m ]} ( n , E )$$

is a quantity of symbol sequences over [symbol] ₘ and each sequence having length n and energy at most equal to E. When the underlying size m is clear from the context, N_{c}(n, E) can be used as a proxy.

The number N_{c}(n, E) is a cumulative sequence quantity that can be calculated using recursion. For example, for each n≥1, N_{c}(n, E) satisfies the recursion:

$${N}_{c} ( n , E ) = {\sum }_{i = 1}^{m} {N}_{c} ( n - 1 , E - E ( {a}_{i} ) ) . \qquad ( 5 )$$

The recursion has an initialization, as shown in Equation (6), where [symbol] denotes the indicator function of the set [0, ∞):

$${N}_{c} ( 0 , E ) = {[ 0 , ∞ )}_{} ( E ) . \qquad ( 6 )$$

The example below uses N(n, E) and N_{c}(n, E) (as well as other concepts) to perform encoding. The examples below may refer to N(n, E) as a sequence quantity and may refer to N_{c}(n, E) as a cumulative sequence quantity.

### One-Step Energy-Based AC Encoding Method

The set of all symbol sequences of length n and over [symbol] ₘ can be denoted by [symbol] (m, n, Ē). Each such sequence has energy at most equal to E. In other words, for any

$${s}_{1}^{n} ∈ 𝒮 ( m , n , \overline{E} ) ,$$

the relationship E(s₁ⁿ)≤Ē holds true. The cardinality of the set [symbol] (m, n, Ē), i.e., the quantity of sequences in [symbol] (m,n,Ē), is represented by:

$$\vert 𝒮 ( m , n , \overline{E} ) \vert = {N}_{c}^{[ m ]} ( n , \overline{E} ) . \qquad ( 7 )$$

When the underlying size m is clear from the context, the notation N_{c}(n, E) can be used as a proxy for

$${N}_{c}^{[ m ]} ( n , \overline{E} ) .$$

The maximum energy, Ē, depends on [symbol] ₘ and n. For example, if it is assumed that the minimum symbol energy and the maximum symbol energy are respectively E(a₁) and E(aₘ), then the minimum energy and the maximum energy of a length-n symbol sequence over Aₘ are respectively equal to nE(a₁) and nE(aₘ), which respectively gives the smallest and the largest meaningful Ē.

A particular form of E is an, where a is between E(a₁) and E(aₘ) and n is the sequence length. For example, α can be taken as the average symbol energy, i.e.,

$$α = {Σ}_{i = 1}^{m} E ( {a}_{i} ) / m .$$

The energy α can be taken as a function of e^{-v}, where v is the parameter of some Maxwell-Boltzmann (MB) distribution. Note that some examples of the one-step energy-based AC encoding method (also referred to as the one-step method) do not rely on any one specific choice of Ē.

Some examples may provide efficient ways to encode (e.g., map) length-k bit sequences into length-n sequences in [symbol] (m, n, Ē) and to guarantee unique decodability.

The one-step method may calculate a dyadic number x from k input information bits. The number k can be selected to be the largest integer such that:

$${2}^{- k} \geq \frac{1}{{N}_{c}^{[ m ]} ( n , \overline{E} )} . \qquad ( 8 )$$

The choice of k guarantees that the mapping is injective. A k-bit sequence (u₁, u₂, . . . , uₖ) may be interpreted as a dyadic number x ∈ [0, 1) with the binary expansion 0.u₁u₂ . . . uₖ:

$$x = {\sum }_{i = 1}^{k} {u}_{i} {2}^{- i} . \qquad ( 9 )$$

The dyadic number x, alpabet , [symbol] ₘ, symbol sequence length n and maximum energy Ē are available for encoding. The one-step method maps the sequence (u₁, u₂, . . . ,uₖ) to a length-n symbol sequence s=(s₁, s₂, . . . , sₙ) in [symbol] (m, n, Ē).

Based on the input k-bit sequence (and the dyadic number x), alphabet [symbol] ₘ, symbol sequence length n and maximum energy Ē, the one-step method sequentially determines an output sequence s=(s₁, s₂, . . . , sₙ) ∈ [symbol] (m, n, Ē) in n iterations. In each iteration, a single symbol is determined. Encoding involves accessing (e.g., computing or approximating or table-looking-up) a plurality of N_{c} cumulative sequence quantities.

The first argument of each such N_{c} cumulative sequence quantity is based on a residual length. The second argument of each such N_{c} cumulative sequence quantity is based on a residual maximum energy. The one-step method examples may include computing ratios based on these N_{c} cumulative sequence quantities. Each such ratio represents a transition probability and is proportional to an N_{c} cumulative sequence quantity, e.g., a normalization is performed, and the ratios sum up to 1. These ratios form a partition of the unit interval [0, 1) into subintervals with lengths equal to the ratios. The ordering of the partitioned subintervals corresponds to the ordering of the symbols in the alphabet.

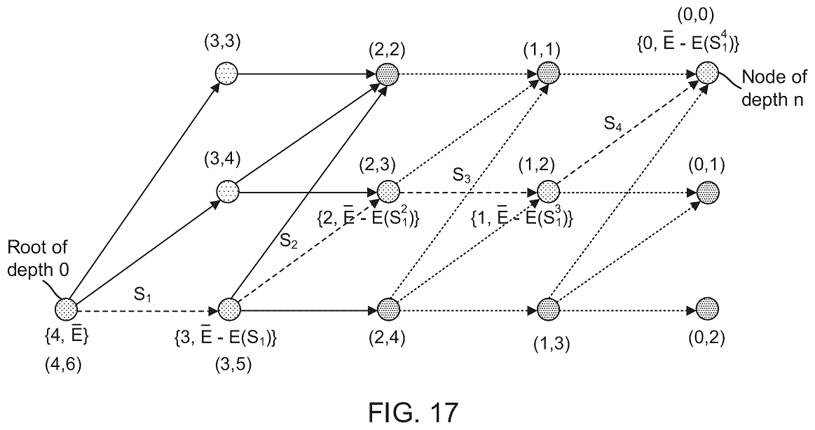

The determination of the symbols is based on the ratios and the (scaled) input x, and each subsequent iteration may include a scaling operation related to x and an update of the residual length and the residual maximum energy. For example, the residual length may be decreased by 1, and the residual maximum energy may be decreased by the energy of the determined symbol. The examples include two types of associations to encoding. In a first example (such as in FIGS. 6-9), a unit interval [0, 1) refinement process can be associated to the one-step method, and in another example (such as in FIG. 17) a rooted graph with directed edges can be associated to the one-step method.

The one-step method may be performed by a UE 115 or a BS 105 and, more specifically, by a wireless communication device, such as illustrated by FIG. 2 and implemented according to the examples of FIGS. 3-5. For a given operation of the one-step method, the variables may start off being initialized. For instance, one example may initialize t=0, nₜ=n, Eₜ=Ē and xₜ=x.

The one-step method iterates the following until (and including) t=n−1. First, an iteration t may access N_{c}(nₜ−1, Eₜ−E(aᵢ)) for each i ∈{1, 2, . . . , m} and access N_{c}(nₜ, Eₜ). Then, for each i ∈{1, 2, . . . , m}, the iteration t computes multiple ratios as follows in Equation (10), where each ratio represents a transition probability:

$${p}_{t + 1} ( {a}_{i} ) {=}^{Δ} \frac{{N}_{c} ( {n}_{t} - 1 , {E}_{t} - E ( {a}_{i} ) )}{{N}_{c} ( {n}_{t} , {E}_{t} )} . \qquad ( 10 )$$

In Equation (10), the symbol “≙” indicates that the left-hand side is defined to be equal to the right-hand side.

Then, the iteration t determines j=jₜ₊₁ ∈ {1, 2, . . . , m} such that:

$${x}_{t} ∈ [ {\sum }_{i = 1}^{j - 1} {p}_{t + 1} ( {a}_{i} ) , {\sum }_{i = 1}^{j} {p}_{t + 1} ( {a}_{i} ) ) . \qquad ( 11 )$$

Then, the iteration t selects output symbol sₜ₊₁ by setting sₜ₊₁=aⱼ and updates the value of x by scaling x, to xₜ₊₁, i.e., compute:

$${x}_{t + 1} = \frac{{x}_{t} - {Σ}_{i = 1}^{j - 1} {p}_{t + 1} ( {a}_{i} )}{{p}_{t + 1} ( {a}_{j} )} . \qquad ( 12 )$$

The iteration t computes nₜ₊₁=nₜ−1 and Eₜ₊₁=Eₜ−E(sₜ₊₁), and then increases t by 1, and this completes iteration t.

In some examples, the value N_{c}(n, [symbol] ) for general n and [symbol] can be accessed by any appropriate technique. In this example, [symbol] is a nonnegative integer smaller than or equal to Ē and n is a nonnegative integer smaller than or equal to n. The numbers m, n and Ē correspond to [symbol] (m, n, Ē), the set of all sequences generated using the alphabet [symbol] ₘ, each sequence having a length n, and having an energy that may be less than or equal to (e.g., at most) Ē. In a first example, N_{c}(n, [symbol] ) may be computed exactly and directly, e.g., using the recursive definition. In a second example, it may be accessed in a look-up table storing such values. In a third example, it may be approximated by an approximation method, in which case the approximate value is denoted by [symbol] (n, [symbol] ).

Also, for a generic t ∈ {0, 1, . . . , n−1}, the first t iterations determine t symbols (s₁, s₂, . . . , sₜ). The encoding process enters iteration t+1, and before symbol sₜ₊₁ is determined, the residual length nₜ and residual maximum energy Ēₜ are given by Equations (13) and (14):

$${n}_{t} = n - t and \qquad ( 13 )$$

$${E}_{t} = \overline{E} - E ( {s}_{1}^{t} ) = \overline{E} - {\sum }_{l = 1}^{t} E ( {s}_{l} ) . \qquad ( 14 )$$

The residual length gives the number of symbols yet to be determined. The residual maximum energy gives the maximum that the total energy of the to-be-determined symbols can have.

The cumulative sequence quantity N_{c}(nₜ−1, Eₜ−E(aᵢ)) in the numerator computing pₜ₊₁(aᵢ) has the following interpretation: if symbol sₜ₊₁ were to be chosen as aᵢ, then the residual length nₜ would decrease by 1 and the residual maximum energy Eₜ would decrease by E(aᵢ). The number of symbol sequences in [symbol] (m, n, Ē) and having (s₁, s₂, . . . , sₜ, aᵢ) as a prefix of length t+1 is equal to N_{c}(nₜ−1, Eₜ−E(aᵢ)), which denotes the number of symbol sequences (over [symbol] ₘ) having length nₜ−1 and energy at most Eₜ−E(aᵢ).

Regarding the ratios pₜ₊₁(aᵢ), for a general t, if exact N_{c} cumulative sequence quantities are used, pₜ₊₁(aᵢ) are nonnegative and sum up to 1 when aᵢ ranges over [symbol] ₘ.

When approximate cumulative sequence quantities [symbol] of N_{c} are used, pₜ₊₁(aᵢ) is computed according to the normalization:

$${p}_{t + 1} ( {a}_{i} ) = \frac{( {n}_{c} - 1 , {E}_{t} - E ( {a}_{i} ) )}{{Σ}_{l = 1}^{m} ( {n}_{c} - 1 , {E}_{t} - E ( {a}_{l} ) )} . \qquad ( 15 )$$

If pₜ₊₁(aᵢ) is computed in accordance with Equation (10), then pₜ₊₁(aᵢ) is proportional to an exact cumulative sequence quantity. If pₜ₊₁(aᵢ) is computed in accordance with Equation (15), then pₜ₊₁(aᵢ) is proportional to an approximate cumulative sequence quantity.

Regarding the determination of the symbols sₜ, the intervals used to decide where xₜ locates (which further determines sₜ₊₁) are of the form:

$$[ {\sum }_{i = 1}^{j - 1} {p}_{t + 1} ( {a}_{i} ) , {\sum }_{i = 1}^{j} {p}_{t + 1} ( {a}_{i} ) ) . \qquad ( 16 )$$

In the determination of symbol sₜ₊₁, the ordering<imposed on the alphabet [symbol] ₘ(a₁< a₂< . . . < aₘ) is implicitly used.

The following is another explanation of iterations in the one-step method, which may be performed by a UE 115 or a BS 105 and, more specifically, by a wireless communication device, such as illustrated by FIG. 2 and implemented according to the examples of FIGS. 3-5. In some examples, in a first iteration (e.g., t=0), the wireless communication device may access a first plurality of cumulative sequence quantities, e.g., N_{c}(n−1,Ē−E(aᵢ)). Each cumulative sequence quantity corresponds to a respective symbol in the symbol alphabet [symbol] ₘ. The wireless communication device may further determine a first plurality of transition probabilities based at least in part on the first plurality of cumulative sequence quantities and in accordance with Equation (10) or (15); for example,

$${p}_{1} ( {a}_{i} ) = \frac{{N}_{c} ( n - 1 , E - \overline{E} ( {a}_{i} ) )}{{N}_{c} ( n , \overline{E} )} . \qquad ( 17 )$$

Each transition probability of the first plurality of transition probabilities corresponds to a respective symbol in symbol alphabet [symbol] ₘ and each transition probability of the first plurality of transition probabilities is proportional to a respective cumulative sequence quantity of the first plurality of cumulative sequence quantities. For example, the transition probability p₁(a) corresponds to symbol a₁ and p₁(a) is proportional to N_{c}(n−1,E−E(aᵢ)). The wireless communication device may partition a first interval into a first plurality of subintervals based at least in part on the first plurality of transition probabilities. Each subinterval of the first plurality of subintervals corresponds to a respective transition probability of the first plurality of transition probabilities, and the length of each subinterval of the first plurality of subintervals is proportional to a respective transition probability of the first plurality of transition probabilities. For example, the subinterval corresponding to p₁(aᵢ) is

$$[ {Σ}_{κ = 0}^{i - 1} {p}_{1} ( {a}_{κ} ) , {Σ}_{κ = 0}^{i} {p}_{1} ( {a}_{κ} ) ) ,$$

and the length of this subinterval is equal to p₁(aᵢ).

The wireless communication device may further identify a first subinterval of the first interval using a first number x₀ equals x in Equation (9) and based at least in part on the first plurality of subintervals. The wireless communication device may determine that the first number lies within the first interval in a portion that corresponds to the first subinterval. In other words, the first number corresponds to a first transition probability to which the first subinterval also corresponds. The wireless communication device may identify a first energy transition value to which the first transition probability corresponds. The wireless communication device may select the first energy transition value and determine a first symbol s₁ of the output symbol sequence s to correspond to the first energy transition value.

The wireless communication device may further apply a scaling operation to the number x₀ according to Equation (12), thereby resulting in a second number x₁. Additionally, the wireless communication device may apply a scaling operation on the first subinterval, thereby generating a scaled first subinterval. The wireless communication device may update the residual length and the residual energy so that nₙ−1 and E₁ Ē−E(s₁).

In some examples, in a subsequent iteration (e.g., t=1) in which n>1, the wireless communication device may access a second plurality of cumulative sequence quantities, e.g., N_{c}(n₁−1, E₁−E(aᵢ)). Each cumulative sequence quantity corresponds to a respective symbol in the symbol alphabet [symbol] ₘ. The wireless communication device may further determine a second plurality of transition probabilities based at least in part on the second plurality of cumulative sequence quantities and in accordance with Equation (10) or (15); for example,

$${p}_{2} ( {a}_{i} ) = \frac{{N}_{c} ( {n}_{1} - 1 , E - E ( {a}_{i} ) )}{{N}_{c} ( {n}_{1} , {E}_{1} )} . \qquad ( 18 )$$

Each transition probability of the second plurality of transition probabilities corresponds to a respective symbol in symbol alphabet [symbol] ₘ and each transition probability of the second plurality of transition probabilities is proportional to a respective cumulative sequence quantity of the second plurality of cumulative sequence quantities. For example, the transition probability p₂(aᵢ) corresponds to symbol aᵢ and p₂(aᵢ) is proportional to N_{c}(n₁−1, E₁−E(aᵢ)). The wireless communication device may partition the scaled first subinterval into a second plurality of subintervals based at least in part on the second plurality of transition probabilities. Each subinterval of the second plurality of subintervals corresponds to a respective transition probability of the second plurality of transition probabilities, and the length of each subinterval of the second plurality of subintervals is proportional to a respective transition probability of the second plurality of transition probabilities. For example, the subinterval corresponding to p₂(aᵢ) is

$$[ {Σ}_{κ = 0}^{i - 1} {p}_{2} ( {a}_{κ} ) , {Σ}_{κ = 0}^{i} {p}_{2} ( {a}_{κ} ) ) ,$$

and the length of this subinterval is equal to p₂(aᵢ).

The wireless communication device may further identify a second subinterval of the scaled first subinterval using the second number x₁ and based at least in part on the second plurality of subintervals. The wireless communication device may determine that the second number lies within the scaled first subinterval in a portion that corresponds to the second subinterval. In other words, the second number corresponds to a second transition probability to which the second subinterval also corresponds. The wireless communication device may identify a second energy transition value to which the second transition probability corresponds. The wireless communication device may select the second energy transition value and determine a second symbol s₂ of the output symbol sequence s to correspond to the second energy transition value. The wireless communication device may further apply a scaling operation to the number x₁ according to Equation (12), thereby resulting in a third number x₂. Additionally, the wireless communication device may apply a scaling operation on the second subinterval, thereby generating a scaled second subinterval. The wireless communication device may update the residual length and the residual energy so that n₂=n₁−1 and E₂=E₁−E(s₂). Further iterations may be performed (if any remain). Interval-Based Representation of the One-Step Energy-Based AC Encoding Method

FIGS. 6-9 illustrate an example method for arithmetic coding using a one-step method according to one implementation. The example method of FIGS. 6-9 may be performed by a UE 115 or a BS 105 and, more specifically, by a wireless communication device, such as illustrated by FIG. 2 and implemented according to the examples of FIGS. 3-5. For instance, a processor or other logic device may execute firmware or software instructions to provide the functionality of the example method of FIGS. 6-9. In the method of FIGS. 6-9, the number of iterations is equal to the number of amplitude symbols (n), which in this example is four, and the maximum energy is six. However, it is understood that the scope of implementations is not limited to any specific number of iterations or maximum energy, and the number of iterations and maximum energy may be determined as appropriate for any particular application.

A unit interval [0, 1) refinement process including n iterations can be associated to the one-step energy-based AC encoding method. The unit interval [0, 1)=[x₀, x̅₀) is successively refined to [xₙ, x̅ₙ):

$$[ {\underline{x}}_{0} , {\overline{x}}_{0} ) ⊇ [ {\underline{x}}_{1} , {\overline{x}}_{1} ) ⊇ [ {\underline{x}}_{2} , {\overline{x}}_{2} ) ⊇ … ⊇ [ {\underline{x}}_{n} , {\overline{x}}_{n} ) ∋ x . \qquad ( 19 )$$

For a general t ∈ {0, 1, . . . , n−1}, the interval refinement is:

$${\underline{x}}_{t + 1} = {\underline{x}}_{t} + ( {\overline{x}}_{t} - {\underline{x}}_{t} ) {\sum }_{i = 1}^{{j}_{t + 1} - 1} {p}_{t + 1} ( {a}_{i} ) , \qquad ( 20 )$$

$${\overline{x}}_{t + 1} = {\underline{x}}_{t} + ( {\overline{x}}_{t} - {\underline{x}}_{t} ) {\sum }_{i = 1}^{{j}_{t + 1}} {p}_{t + 1} ( {a}_{i} ) \qquad ( 21 )$$

The interval [xₜ, x̅ₜ) corresponds to the symbols determined during the first t iterations, i.e., the prefix (s₁, s₂, . . . , sₜ), and it satisfies the following relations:

$$\frac{{\overline{x}}_{t + 1} - {\underline{x}}_{t + 1}}{{\overline{x}}_{t} - {\underline{x}}_{t}} = {p}_{t + 1} ( {s}_{t + 1} ) \qquad ( 22 )$$

$${\overline{x}}_{t + 1} - {\underline{x}}_{t + 1} = {\prod }_{i = 1}^{t + I} {p}_{i} ( {s}_{i} ) . \qquad ( 23 )$$

The dyadic number x obtained from the input bit sequence (u₁,u₂, . . . , uₖ) satisfies x ∈ [xₜ₊₁, x̅ₜ₊₁) if and only if the following relation is true:

$${x}_{t} ∈ [ {\sum }_{i = 1}^{{j}_{t + 1} - I} {p}_{t + 1} ( {a}_{i} ) , {\sum }_{i = 1}^{{j}_{t + 1}} {p}_{t + 1} ( {a}_{i} ) ) . \qquad ( 24 )$$

In this example, xₜ refers to the scaling variable in the one-step method. The ratio of two consecutive refined intervals satisfies:

$$\frac{{\overline{x}}_{t + 1} - {\underline{x}}_{t + 1}}{{\overline{x}}_{t} - {\underline{x}}_{t}} = {p}_{t + 1} ( {s}_{t + 1} ) ) = \frac{{N}_{c} ( {n}_{c} - 1 , {E}_{t} - E ( {s}_{t + 1} ) )}{{N}_{c} ( {n}_{t} , {E}_{t} )} . \qquad ( 25 )$$

Moreover, the last refined interval has length:

$$\vert [ {\underline{x}}_{n} , {\overline{x}}_{n} ) \vert = {\prod }_{i = 1}^{n} {p}_{i} ( {s}_{i} ) = \frac{1}{{N}_{c} ( n , \overline{E} )} . \qquad ( 26 )$$

When x (arbitrarily) varies in [0, 1), e.g., it is the realization of a random variable uniformly distributed over [0, 1), the refinement process results in a partitioning of [0,1) into subintervals of equal size 1/N_{c}(n, Ē). Each length-n symbol sequence in [symbol] (m, n, Ē) corresponds to a distinct subinterval. The ordering of the subintervals corresponds to a lexicographical ordering of the symbol sequences which further depends on the ordering of the symbols in [symbol] ₘ.

In the example of FIGS. 6-9, m=3 and the symbol alphabet is [symbol] ₃={a₁, a₂, a₃} with an ordering< over the alphabet such that a₁< a₂< a₃. Symbol energies in this example are respectively E(a₁)=1, E(a₂)=2 and E(a₃)=3.

Symbol sequences (over [symbol] ₃) having length n=4 and energy at most Ē=6 is denoted by [symbol] (3, 4, 6). Sequences in [symbol] (3, 4, 6) include:
1 sequence having energy 4: (a₁, a₁, a₁, a₁), since 4E (a₁)=4;
4 sequences each having energy α: (a₁, a₁, a₁, a₂), (a₁, a₁, a₂, a₁), (a₁, a₂, a₁, a₁) and
(a₂, a₁, a₁, a₁), since 3E(a₁)+E(a₂)=5; and
10 sequences each having energy 6:

$$( {a}_{1} , {a}_{1} , {a}_{2} , {a}_{2} ) , ( {a}_{1} , {a}_{2} , {a}_{1} , {a}_{2} ) , ( {a}_{1} , {a}_{2} , {a}_{2} , {a}_{1} )$$

$$( {a}_{2} , {a}_{1} , {a}_{1} , {a}_{2} ) , ( {a}_{2} , {a}_{1} , {a}_{2} , {a}_{1} ) , ( {a}_{2} , {a}_{2} , {a}_{1} , {a}_{1} )$$

$$( {a}_{1} , {a}_{1} , {a}_{1} , {a}_{3} ) , ( {a}_{1} , {a}_{1} , {a}_{3} , {a}_{1} ) , ( {a}_{1} , {a}_{3} , {a}_{1} , {a}_{1} ) , ( {a}_{3} , {a}_{1} , {a}_{1} , {a}_{1} ) .$$

This means that

$$( {a}_{2} , {a}_{1} , {a}_{1} , {a}_{2} ) , ( {a}_{2} , {a}_{1} , {a}_{2} , {a}_{1} ) , ( {a}_{2} , {a}_{2} , {a}_{1} , {a}_{1} ) ,$$

$$( {a}_{1} , {a}_{1} , {a}_{1} , {a}_{3} ) , ( {a}_{1} , {a}_{1} , {a}_{3} , {a}_{1} ) , ( {a}_{1} , {a}_{3} , {a}_{1} , {a}_{1} ) , ( {a}_{3} , {a}_{1} , {a}_{1} , {a}_{1} ) .$$

which is the total number of sequences in the set [symbol] (3, 4, 6). In this case the largest k satisfying the input condition is k=3, i.e., 2⁻³≥1/15. The 3-bit sequence (1, 0, 0) is the input and the dyadic number corresponding to (1, 0, 0) is x=x₀=0.5.

FIG. 6 illustrates a first iteration of the one-step method, and the first iteration selects a first energy transition value and defines a first subinterval from a first interval. The first interval at t=0 is from 0 to 1.

The encoding starts with x₀=x=0.5, n₀=4 and E₀=6. Cumulative sequence quantities are evaluated as N_{c}(3, 5)=10, N_{c}(3, 4)=4, N_{c}(3, 3)=1. Ratios, which represent transition probabilities, are then given by:

$${p}_{1} ( {a}_{1} ) = \frac{{N}_{c} ( {n}_{0} - 1 , {E}_{0} - E ( {a}_{1} ) )}{{N}_{c} ( {n}_{0} , {E}_{0} )} = \frac{10}{15} , \qquad ( 27 )$$

$${p}_{1} ( {a}_{2} ) = \frac{{N}_{c} ( {n}_{0} - 1 , {E}_{0} - E ( {a}_{2} ) )}{{N}_{c} ( {n}_{0} , {E}_{0} )} = \frac{4}{15} , \qquad ( 28 )$$

$${p}_{1} ( {a}_{3} ) = \frac{{N}_{c} ( {n}_{0} - 1 , {E}_{0} - E ( {a}_{3} ) )}{{N}_{c} ( {n}_{0} , {E}_{0} )} = \frac{1}{15} . \qquad ( 29 )$$

These ratios effectively form a partition of [0, 1) into subintervals [0,p₁(a₁)), [p₁(a₁),p₁(a₁)+p₁(a₂)) and [p₁(a₁)+p₁(a₂), 1) with respective lengths p₁(a₁), p₁(a₂) and p₁(a₃); they respectively correspond to a₁, a₂ and a₃ (note the ordering a₁< a₂< a₃) and each symbol corresponds to a potential choice for the first output symbol s₁.

The ratios are ordered with respect to the ordering of the alphabet symbols, so the largest ratio (10/15) begins at zero within the interval, the next largest ratio (4/15) begins at 10/15 and extends to 14/15 within the interval, and the smallest ratio (1/15) begins at 14/15 and extends to 15/15 within the interval.

A function to produce a dyadic number is performed on the k bits to generate x₀. In this example, the function gives x₀=0.5, which falls within the first interval at a point that is within the first ratio (10/15). In other words, the value of x₀ is within the range [0,10/15), and that ratio is selected. The ratio 10/15 corresponds to a₁, which itself corresponds to the first energy transition value, which is 1. As shown above, E(aᵢ) is 1. Or put another way, the first subinterval corresponds to a₁ and corresponds to the set of symbol sequences each having length n₀=4, energy at most E₀=6, and having a₁ as the prefix of length 1. The selected symbol (s₁) is a₁.

The dyadic number x₀ is scaled to give x₁. The number n is reduced by 1 the energy is reduced from the maximum energy by subtracting E(s₁).

In one example of scaling x, since x₀=x=0.5 E [0, 10/15), j is determined as j₁=1 and the first output symbol s₁=a₁.

Then, x₀ is scaled to x₁ according to:

$${x}_{1} = \frac{{x}_{0} - 0}{{p}_{1} ( {s}_{1} )} = 0.75 . \qquad ( 30 )$$

Then, n₀ and E₀ are updated respectively to: n₁=n₀−1=3 and E₁=E₀−E(s₁)=5.

The number t is increased by 1 and t reaches 1. The operation to scale x₀ to x₁ can be explained as follows: the action of the next (second) iteration is (1) further partitioning the subinterval corresponding to s₁ into subintervals with lengths proportional to the involved ratios (that is, [0, 6/15), [6/15,9/15) and [9/15,1) have lengths proportional to 6/10, 3/10 and 1/10) and (2) determining s₂ by determining where x₀=x locates in one of those subintervals. By scaling x₀ to x₁, the above is then equivalent to determining where x₁ locates in one of the subintervals with lengths equal to the involved ratios (i.e., [0, p₂(aᵢ)), [p₂(aᵢ), p₂(aᵢ)+p₂(a₂)) and [p₂(a₁)+p₂(a₂), 1)).

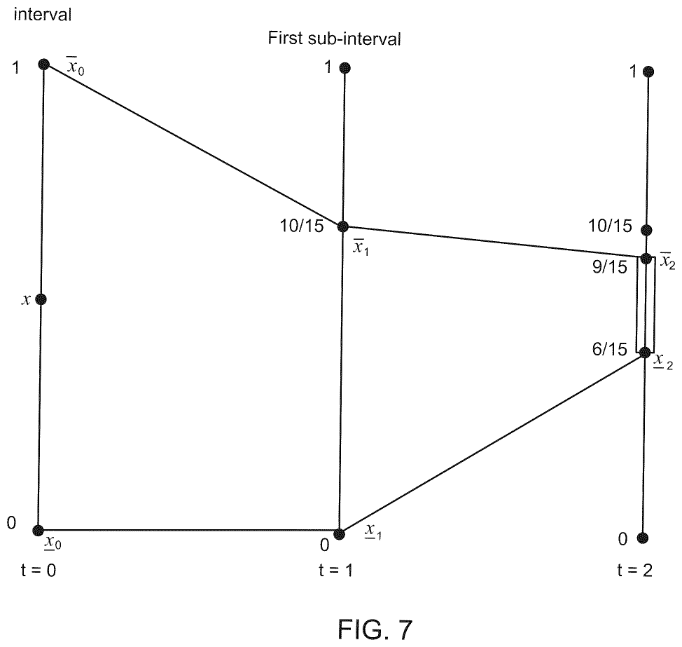

FIG. 7 illustrates a second iteration. The second iteration calculates three ratios again, and each of the individual ratios corresponds to a respective portion of the first subinterval. For instance, the encoding takes x₁=0.75, n₁=3 and E₁=5.

Cumulative sequence quantities are evaluated as N_{c}(2, 4)=6, N_{c}(2, 3)=3, N_{c}(2, 3)=1. Ratios are then given by:

$${p}_{2} ( {a}_{1} ) = \frac{{N}_{c} ( {n}_{1} - 1 , {E}_{1} - E ( {a}_{1} ) )}{{N}_{c} ( {n}_{1} , {E}_{1} )} = \frac{6}{15} , \qquad ( 31 )$$

$${p}_{2} ( {a}_{2} ) = \frac{{N}_{c} ( {n}_{1} - 1 , {E}_{1} - E ( {a}_{2} ) )}{{N}_{c} ( {n}_{1} , {E}_{1} )} = \frac{3}{15} , \qquad ( 32 )$$

$${p}_{2} ( {a}_{3} ) = \frac{{N}_{c} ( {n}_{1} - 1 , {E}_{1} - E ( {a}_{3} ) )}{{N}_{c} ( {n}_{1} , {E}_{1} )} = \frac{1}{15} , \qquad ( 33 )$$

The first ratio (6/10) corresponds to the range [0,6/15), the second ratio (3/10) corresponds to the range [6/15,9/15), and the third ratio (1/10) corresponds to the range [9/15,10/15). Since x₁ is equal to 0.75, the value of x₁ falls within the range [6/10,9/10), so the second ratio is selected. The ratio 3/10 corresponds to a₂, which itself corresponds to the second energy transition value, which is E(a₂)=2. The second iteration then defines the second subinterval as [6/15,9/15), corresponding to the second ratio and the second energy transition value. The selected symbol (s₂) is a₂.

Thus, the second subinterval corresponds to a₂ and corresponds to the set of sequences (over [symbol] ₃) each having n₀=4, energy at most E₀=6, and having (a₁, a₂) as the prefix of length 2. The total number of such sequences is N_{c}(n₁−1, E₁-E(a₂))=3. The second iteration further includes scaling x₁ to give x₂ according to:

$${x}_{2} = \frac{{x}_{1} - 6 / 10}{{p}_{2} ( {s}_{2} )} = 0.5 . \qquad ( 34 )$$

Then, n₁ and E₁ are updated respectively to n₂=n₁−1=2 and E₂=E₁-E(s₂)=3. Then, t is increased by 1 and t reaches 2.

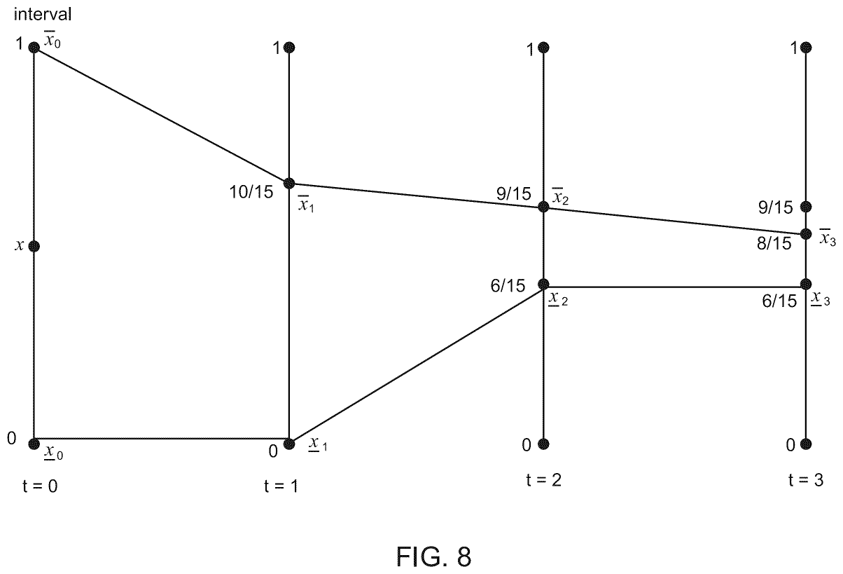

FIG. 8 illustrates a third iteration. The third iteration calculates three ratios again, and each of the individual ratios correspond to a respective portion of the second subinterval. For instance, the third iteration takes x₂=0.5, n₂=2 and E₂=3 and evaluates cumulative sequence quantities N_{c}(1, 2)=2, N_{c}(1, 1)=1, N_{c}(1, 0)=0. Ratios are then given by:

$${p}_{3} ( {a}_{1} ) = \frac{{N}_{c} ( {n}_{2} - 1 , {E}_{2} - E ( {a}_{1} ) )}{{N}_{c} ( {n}_{2} , {E}_{2} )} = \frac{2}{3} , \qquad ( 35 )$$

$${p}_{3} ( {a}_{2} ) = \frac{{N}_{c} ( {n}_{2} - 1 , {E}_{2} - E ( {a}_{2} ) )}{{N}_{c} ( {n}_{2} , {E}_{2} )} = \frac{1}{3} , \qquad ( 36 )$$

$${p}_{3} ( {a}_{2} ) = \frac{{N}_{c} ( {n}_{2} - 1 , {E}_{2} - E ( {a}_{2} ) )}{{N}_{c} ( {n}_{2} , {E}_{2} )} = 0. \qquad ( 37 )$$

The first ratio (2/3) corresponds to the range [6/15,8/15), the second ratio (1/3) corresponds to the range [8/15,9/15), and the third ratio (0) corresponds to a range of 0. Since x₂ is equal to 0.5, the value of x₂ falls within the range [0, 2/3), so the method selects the first ratio. The ratio 2/3 corresponds to aᵢ, which itself corresponds to the third energy transition value, which is E(aᵢ)=1. The third iteration then defines the third subinterval as [6/15, 8/15), corresponding to the first ratio and the third energy transition value. The selected symbol (s₃) is a₁. The iteration includes scaling x₂ to give x₃ according to:

$${x}_{3} = \frac{{x}_{2} - 0}{{p}_{3} ( {s}_{3} )} = 0.75 . \qquad ( 38 )$$

Then, n₂ and E₂ are updated respectively to n₃=n₂−1=1 and E₃=E₂−E(s₃)=2. Then, t is increased by 1 and t reaches 3.

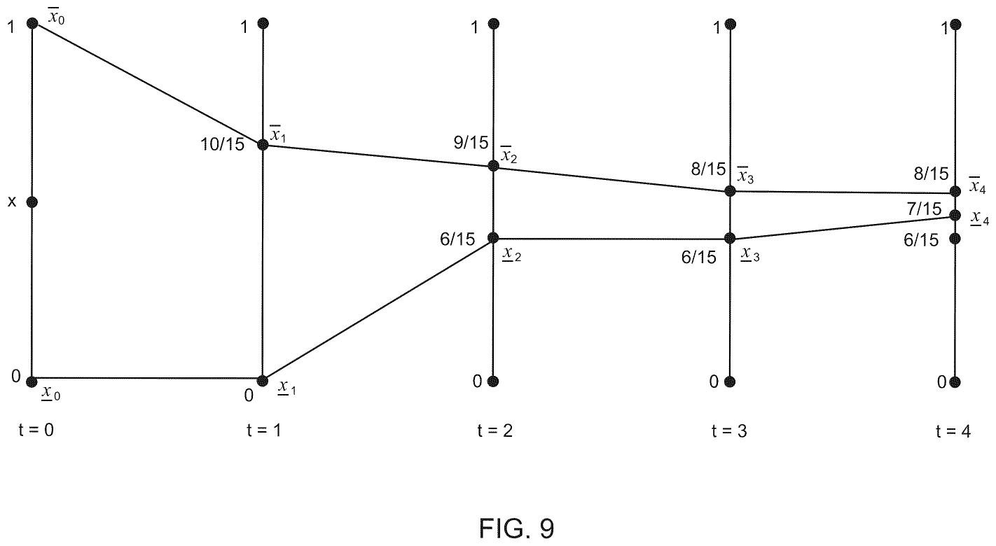

FIG. 9 illustrates a fourth iteration of the one-step method. The fourth iteration calculates three ratios again, and each of the individual ratios correspond to a respective portion of the third subinterval. For instance, the fourth iteration takes x₃=0.75, n₃=1 and E₃=2 and evaluates cumulative sequence quantities N_{c}(0, 1)=1, N_{c}(0, 0)=1, N_{c}(1, −1)=0. Ratios are then given by:

$${p}_{4} ( {a}_{1} ) = \frac{{N}_{c} ( {n}_{3} - 1 , {E}_{3} - E ( {a}_{1} ) )}{{N}_{c} ( {n}_{2} , {E}_{2} )} = \frac{1}{2} , \qquad ( 39 )$$

$${p}_{4} ( {a}_{2} ) = \frac{{N}_{c} ( {n}_{3} - 1 , {E}_{3} - E ( {a}_{2} ) )}{{N}_{c} ( {n}_{3} , {E}_{3} )} = \frac{1}{2} , \qquad ( 40 )$$

$${p}_{4} ( {a}_{3} ) = \frac{{N}_{c} ( {n}_{3} - 1 , {E}_{3} - E ( {a}_{3} ) )}{{N}_{c} ( {n}_{3} , {E}_{3} )} = 0. \qquad ( 41 )$$

The first ratio (1/2) corresponds to the range [6/15,7/15), the second ratio (1/2) corresponds to the range [7/15, 8/15), and the third ratio (0) corresponds to a range of 0. Since x₃ is equal to 0.75, the value of x₃ falls within the range [1/2, 1), so the method selects the second ratio. The second ratio 1/2 corresponds to a₂, which itself corresponds to the fourth energy transition value, which is E(a₂)=2. The method then defines the fourth subinterval as [7/15,8/15), corresponding to the second ratio and the fourth energy transition value. The selected symbol (s₄) is a₂.

The method then further reduces n₃ by 1 and reduces E₃ by further subtracting E(s₄), so that both n₄ and E₄ equal zero, indicating that the number of iterations is complete for the set of k=3 bits. The sequence of length n is (s₁, s₂, s₃, s₄), and it corresponds to the final number 7/15.

### Graphical Representation of the One-Step Energy-Based AC Encoding Method

Another way to represent the one-step method described above is with a graphical representation, such as shown in FIG. 17. The example of FIG. 17 has n=4 for simplicity, just as in FIGS. 6-9. The graph of FIG. 17 is sometimes referred to as a rooted graph with directed edges. The root is of depth 0 and corresponds to {n, Ē}representing the set of symbol sequences (over [symbol] ₘ) each having length n and energy at most E. The graph also includes nodes. A generic node of depth t≤n corresponds to (e.g., is labelled by)

$$\{ n - t , \overline{E} - E ( {s}_{1}^{t} ) \} .$$

Such a node represents the set of symbol sequences (over [symbol] ₘ) each having length n−t and energy at most

$$\overline{E} - E ( {s}_{1}^{t} ) .$$

### Here,

$${s}_{1}^{t} = ( {s}_{1} , {s}_{2} , … , {s}_{t} )$$

is the prefix of a symbol sequence s ∈ [symbol] (m, n, Ē). In the one-step method, n−t corresponds to the residual length and

$$\overline{E} - E ( {s}_{1}^{t} )$$

corresponds to the residual maximum energy before symbol sₜ₊₁ is determined.

A directed edge from a node of depth t is of the form:

$$\{ n - t , \overline{E} - E ( {s}_{1}^{t} ) \} \to \{ n - t - 1 , \overline{E} - E ( {s}_{1}^{t + 1} ) \} . \qquad ( 42 )$$

In this example,

$${s}_{1}^{t} = ( {s}_{1} , {s}_{2} , … , {s}_{t} ) and {s}_{1}^{t + 1} = ( {s}_{1} , {s}_{2} , … , {s}_{t} , {s}_{t + 1} ) \} .$$

are the prefixes of a symbol sequence s ∈ [symbol] (m, n, Ē). A path from the root to a node of depth n gives rise a symbol sequence in [symbol] (m, n, Ē).

The cardinality of the set that the node

$$\{ n - t , \overline{E} - E ( {s}_{1}^{t} ) \}$$

represents is equal to

$${N}_{c} ( n - t , \overline{E} - E ( {s}_{1}^{t} ) ) .$$

Since the energies E(aᵢ) are assumed distinct, parent-to-child relation of connected nodes represents a disjoint union, e.g.,

$$\{ n - t , \overline{E} - E ( {s}_{1}^{t} ) \} = \begin{matrix}{⋃}^{m} \\ i = 1\end{matrix} \{ n - t - 1 , \overline{E} - E ( {s}_{1}^{t} ) - E ( {a}_{i} ) \} , \qquad ( 43 )$$

$${N}_{c} ( n - t , \overline{E} - E ( {s}_{1}^{t} ) ) = {\sum }_{i = 1}^{m} {N}_{c} ( n - t - 1 , \overline{E} - E ( {s}_{1}^{t} ) - E ( {a}_{i} ) ) . \qquad ( 44 )$$

Each path ends up with a node of depth n and has the form {0, E′} with some E′≥0, and the total number of distinct paths is equal to the cumulative sequence quantity N_{c}(n, Ē), which is also the cardinality of [symbol] (m, n, Ē).

In the one-step method and for a generic t ∈ {0, 1, . . . , n−1}, the determination of symbol sₜ₊₁ corresponds to the transition from a (parent) node of depth t to a (child) node of depth t+1.

Each pₜ₊₁(aᵢ) can be interpreted as a transition probability from node

$$\{ n - t , \overline{E} - E ( {s}_{1}^{t} ) \}$$

to node

$$\{ n - t - 1 , \overline{E} - E ( {s}_{I}^{t} ) - E ( {a}_{1} ) \}$$

in accordance with:

$${p}_{t + 1} ( {a}_{i} ) = \frac{{N}_{c} ( n - t - 1 , E ( {s}_{1}^{t} ) - E ( {a}_{i} ) )}{{N}_{c} ( n - t , \overline{E} - E ( {s}_{1}^{t} ) )} = \frac{{N}_{c} ( {n}_{t} - 1 , {E}_{t} - E ( {a}_{i} ) )}{{N}_{c} ( {n}_{t} , {E}_{t} )} . \qquad ( 45 )$$

Just as in the interval representation of FIGS. 6-9, the symbols are determined iteratively using the number x and the ratios, which represent transition probabilities. Starting with the root of depth 0, the first iteration determines s₁ by determining that x corresponds to a ratio associated with s₁. The energy Ē and length n are then decremented, the ratios calculated again, and s₂ is determined by determining that the number x corresponds to a ratio associated with s₂. Two more iterations are then performed, decrementing n all the way to 0. Once again, the sequence of length n is (s₁, s₂, s₃, s₄).

### One-Step Energy-Based AC Encoding Method

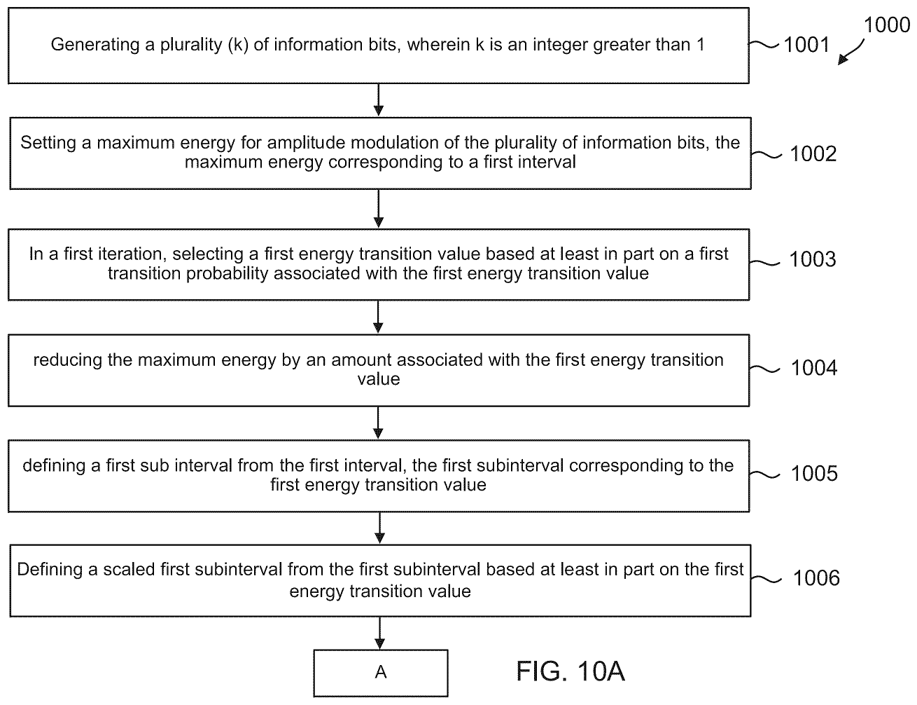

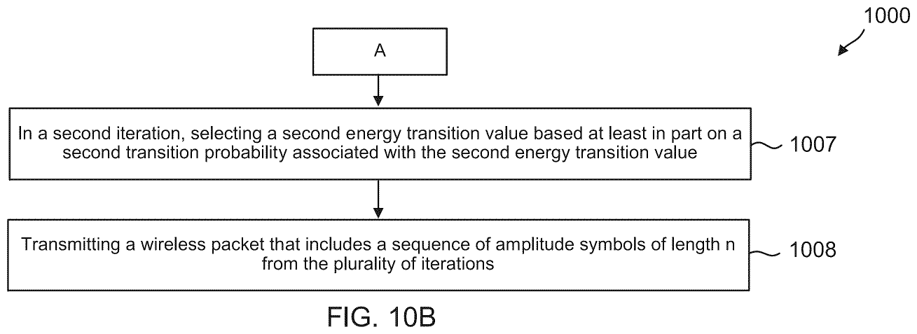

FIGS. 10A and 10B present an illustration of example method 1000 for the one-step method, according to one implementation.

At action 1001, the wireless communication device generates a plurality (k) of information bits. In this example, k is an integer greater than 1.

At action 1002, the wireless communication device sets a maximum energy Ē for amplitude modulation of the plurality of information bits. Further in this example, the maximum energy corresponds to a first interval (e.g., [0, 1)), though any appropriate interval may be used. Through the number of iterations, the energy is reduced, and the first interval is divided into further subintervals. In some implementations, the maximum energy, as well as the length n and the alphabet [symbol] ₘ, are parameters that are selected ahead of time by either a base station or a UE.

Actions 1003-1007 include an encoding operation on the plurality of information bits. The encoding operation has a plurality of iterations, including a first iteration, a second iteration and perhaps further iterations in some implementations. The scope of embodiments is not limited to any number of iterations. For instance, some 5G applications may use a value for n in the hundreds or higher.

At action 1003 the wireless communication device performs a first iteration. For instance, the wireless communication device selects a first energy transition value E(a₁) based at least in part on a first transition probability associated with the first energy transition value. The energy transition value E(a₁) is associated with the amplitude symbol (a₁).

Action 1003 may further include performing a first function to generate x₀, such as the dyadic number function described above. The first function generates a first number x₀ within the first interval (e.g., [0, 1)), and then the wireless communication device may determine that the first number lies within the first interval in a portion that corresponds to the first energy transition value. For example, as noted above, ordering of subintervals within the interval may correspond to a lexicographical ordering of the symbol sequences which further depends on the ordering of the symbols in [symbol] ₘ.

Action 1003 may also include determining a first cumulative sequence quantity (N_{c}) that defines a set of all sequences having a length n and an energy Ē equal to or less than the maximum energy. N_{c} is the total number of sequences in the set [symbol] (m, n, Ē). The first energy transition value is selected from a group of energy transition values representing all possible energy transition values within an alphabet of size m of energy transition values, and m is an integer greater than 1.

Action 1003 may also include calculating the plurality m of ratios p₁(aᵢ), in the first iteration. Each one of the ratios corresponds to a respective transition probability of a given energy transition value within the set of energy transition values. Further, each energy transition value corresponds to an amplitude symbol.

Moving to action 1004, it includes reducing the maximum energy Ē by an amount associated with the first energy transition value. This action sets up the second iteration to begin with the reduced energy (e.g., Ē−E(s₁)) and reduced length (e.g., n−1).

Actions 1005-1007 describe a second iteration, which is performed similarly to the first iteration, but with a reduced energy, reduced length, updated dyadic number. At action 1005, the wireless communication device defines a first subinterval from the first interval. The first subinterval corresponds to the first energy transition value, as it represents the portion of the first interval corresponding to the selected ratio.

At action 1006, the wireless communication device defines a scaled first subinterval from the first subinterval based at least in part on the first energy transition value.

At action 1007, the wireless communication device performs a second iteration. In the second iteration, the wireless communication device selects a second energy transition value based at least in part on a second transition probability associated with a second energy transition value.

Method 1000 may include further iterations, such that n is equal to three or more. The iterations collectively generate a sequence of length n, where n is equal to a total quantity of the plurality of iterations, as expressed by s=(s₁, s₂, . . . , sₙ).

Action 1009 includes transmitting a wireless packet to at least one receiving device based on the sequence. For instance, the sequence may be enhanced by forward error correction, converted into constellation points, and transmitted wirelessly to the receiving device.

### Two-Step Energy-Based AC Encoding Method

The examples above describe the one-step method. Further embodiments include an energy-based AC encoding method that determines a sequence energy in a first iteration and then determines a sequence of amplitude symbols in a second set of iterations. Examples may refer to such embodiments as a two-step energy-based AC encoding method or, simply, as the two-step method. The two-step method may be performed by a UE 115 or a BS 105 and, more specifically, by a wireless communication device, such as illustrated by FIG. 2 and implemented according to the examples of FIGS. 3-5.

The first step of encoding determines the energy of the output sequence. The first step involves accessing (e.g., computing or approximating or table-looking-up) a plurality of N_{c} cumulative sequence quantities. The first step involves computing ratios based on these N_{c} cumulative sequence quantities such that each such ratio is proportional to an N_{c} cumulative sequence quantity. The determination of the energy is based on the ratios and the dyadic number input x. The first step may also involve a scaling operation related to x.

For instance, the first step of encoding determines a number E between 0 and Ē. The number E specifies the energy of the output sequence and it is selected according to:

$$x ∈ [ \frac{{N}_{c} ( n , E - 1 )}{{N}_{c} ( n , \overline{E} )} , \frac{{N}_{c} ( n , E )}{{N}_{c} ( n , \overline{E} )} ) . \qquad ( 46 )$$

Then, the dyadic number x is scaled to x′ according to:

$${x}^{′} = \frac{{N}_{c} ( n , \overline{E} ) x - {N}_{c} ( n , E - 1 )}{N ( n , E )} \qquad ( 47 )$$

The determination of E using the above condition can be realized by a bisection method, since N_{c} is increasing in its second argument. The first step (or, simply step 1) effectively partitions the set [symbol] (m, n, Ē) into subsets, with each subset consisting of all sequences that have equal energy.

The second step of encoding determines each symbol of the output sequence, and this is done sequentially in n iterations. In each iteration of the second step, a single symbol is determined. The second step (or, simply step 2) involves accessing (e.g., computing or approximating or table-looking-up) a plurality of N sequence quantities. The first argument of each such N is based on a residual length. The second argument of each such N is based on a residual energy. Each iteration of the second step involves computing ratios (transition probabilities) based on these N sequence quantities and each such ratio is proportional to an N sequence quantity. The determination of the symbol is based on the ratios and the (scaled) input x. Each iteration of the second step may also involve a scaling operation related to x and an update of the residual length and the residual energy. The residual length is decreased by 1. The residual maximum energy is decreases by the energy of the determined symbol.

For instance, step 2 may include initialization in which t=0, nₜ=n, Eₜ=E and x, =x‘ with E and x’ determined in the first step. A given operation of the two-step method iterates until (and including) t=n−1. Iteration t includes accessing N(nₜ−1,Eₜ−E(aᵢ)) for each i ∈{1, 2, . . . ,m} and accessing N(nₜ,Eₜ). For each i ∈ {1, 2, . . . , m}, an iteration t computes the ratios (transition probabilities):

$${p}_{t + 1} ( {a}_{i} ) {=}^{Δ} \frac{N ( {n}_{c} - 1 , {E}_{t} - E ( {a}_{i} ) )}{N ( {n}_{t} , {E}_{t} )} . \qquad ( 48 )$$

The iteration t determines j=jₜ₊₁ ∈{1, 2, . . . , m} such that the following relation is true:

$${x}_{t} ∈ [ {\sum }_{i = 1}^{j - I} {p}_{t + 1} ( {a}_{i} ) , {\sum }_{i = 1}^{j} {p}_{c + 1} ( {a}_{i} ) ) . \qquad ( 49 )$$

The iteration t outputs symbol sₜ₊₁ by setting sₜ₊₁=aⱼ, and updates the value of x by scaling xₜ to xₜ₊₁ by computing:

$${x}_{t + 1} = \frac{{x}_{t} - {Σ}_{i = 1}^{j - 1} {p}_{t + 1} ( {a}_{i} )}{{p}_{t + 1} ( {a}_{j} )} . \qquad ( 50 )$$

The iteration t computes nₜ₊₁=nₜ−1 and Eₜ₊₁=Eₜ−E(sₜ₊₁) and increase t by 1, and this completes iteration t.

In some examples, the cumulative sequence quantity N_{c}(n, [symbol] ) for general [symbol] used in the first step can be accessed in any appropriate manner. In this example, [symbol] is a nonnegative integer smaller than or equal to Ē. The numbers m, n and Ē correspond to [symbol] (m, n, Ē), the set of all sequences generated using the alphabet [symbol] ₘ, each sequence having a length n, and having an energy that may be less than or equal to (e.g., at most) Ē. In a first example, N_{c}(n, (9) may be computed exactly and directly, e.g., using the recursive definition. In a second example, N_{c}(n, [symbol] ) may be accessed in a look-up table storing such values. In a third example, N_{c}(n, [symbol] ) may be approximated by an approximation method, in which case the approximate value is denoted by [symbol] (n, [symbol] ). If an approximation method is used, the first step of encoding may replace the exact values with approximate values, and selects the number E according to:

$$x ∈ [ \frac{( n , E - 1 )}{( n , \overline{E} )} , \frac{( n , E )}{( n , \overline{E} )} ) . \qquad ( 51 )$$

In some examples, the sequence quantity N(n, [symbol] ) for general n and (used in the second step can be accessed in any appropriate manner. In a first example, N(n, [symbol] ) may be computed exactly and directly, e.g., using the recursive definition. In a second example, N(n, [symbol] ) may be accessed in a look-up table storing such values. In a third example, N(n, [symbol] ) may be approximated by an approximation method, in which case the approximate value is denoted by \hat{N}(n, [symbol] ). If an approximation method is used, the second step of encoding may compute the ratios using the approximate values; e.g., pₜ₊₁(aᵢ) is determined in accordance with:

$${p}_{t + 1} ( {a}_{i} ) = \frac{\hat{N} ( {n}_{t} - 1 , {E}_{t} - E ( {a}_{i} ) )}{{Σ}_{l = 1}^{m} \hat{N} ( {n}_{t} - 1 , {E}_{t} - E ( {a}_{l} ) )} . \qquad ( 52 )$$

The following is another explanation of iterations in the two-step method. The two-step method may be performed by a UE 115 or a BS 105 and, more specifically, by a wireless communication device, such as illustrated by FIG. 2 and implemented according to the examples of FIGS. 3-5. In some examples, the first step includes the wireless communication device accessing a first plurality of cumulative sequence quantities, e.g., N_{c}(n, [symbol] ), wherein (is a nonnegative integer between 0 and Ē. Each cumulative sequence quantity corresponds to a respective energy level smaller than or equal to E. The wireless communication device may further determine a first plurality of ratios based at least in part on the first plurality of cumulative sequence quantities and in accordance with Equation (46) or (51); for example, the ratio corresponding to N_{c}(n, [symbol] ) may be determined according to:

$$\frac{{N}_{c} ( n , 𝔈 )}{{N}_{c} ( n , \overline{E} )} \qquad ( 53 )$$

Each ratio of the first plurality of ratios corresponds to a respective energy level smaller than or equal to E and each ratio of the first plurality of ratios is proportional to a respective cumulative sequence quantity of the first plurality of cumulative sequence quantities. For example, the ratio in Equation (53) corresponds to energy level (and the ratio is proportional to N_{c}(n, [symbol] ). The wireless communication device may partition a first interval into a first plurality of subintervals based at least in part on the first plurality of ratios. Each subinterval of the first plurality of subintervals corresponds to a respective N_{c} sequence quantity, and the length of each subinterval of the first plurality of subintervals is proportional to a respective N sequence quantity. For example, the subinterval corresponding to the cumulative sequence quantity N_{c}(n, [symbol] ) is [N_{c}(n, [symbol] −1)/N_{c}(n, Ē), N_{c}(n, [symbol] )/N_{c}(n, Ē)), and the length of this subinterval is equal to the sequence quantity N(n, [symbol] ).

The wireless communication device may further identify a first subinterval of the first interval using a first number x in accordance with Equation (9) and based at least in part on the first plurality of subintervals. The wireless communication device may determine that the first number lies within the first interval in a portion that corresponds to the first subinterval according to Equation (46) or (51). In other words, the first number corresponds to a first ratio to which the first subinterval also corresponds.

The first subinterval corresponds to all sequences in [symbol] (m, n, Ē) that has energy equal to E. Its length is proportional to N_{c}(n, E)−N_{c}(n, E−1)=N(n, E). In other words, the energy equal to E has been identified by the first step.

The wireless communication device may further apply a scaling operation number x is scaled to x′ according to Equation (47). Additionally, the wireless communication device may apply a scaling operation on the first subinterval, thereby generating a second interval.

The second step begins by initializing t=0, nₜ=n, Eₜ=E and x, =x′ with E and x′ determined in the first step. In a first iteration (e.g., t=0) of the first step, the wireless communication device may access a first plurality of sequence quantities, e.g., N(n−1, Eₜ−E(aᵢ)). Each sequence quantity corresponds to a respective symbol in the symbol alphabet [symbol] ₘ. The wireless communication device may further determine a first plurality of transition probabilities based at least in part on the first plurality of sequence quantities and in accordance with Equation (48) or (52); for example,

$${p}_{1} ( {a}_{i} ) = \frac{N ( n - 1 , \overline{E} - E ( {a}_{i} ) )}{N ( n , \overline{E} )} . \qquad ( 54 )$$

Each transition probability of the first plurality of transition probabilities corresponds to a respective symbol in symbol alphabet [symbol] ₘ and each transition probability of the first plurality of transition probabilities is proportional to a respective sequence quantity of the first plurality of sequence quantities. For example, the transition probability p₁(aᵢ) corresponds to symbol aᵢ and p₁(aᵢ) is proportional to N(n−1, Eₜ−E(aᵢ)). The wireless communication device may partition the second interval obtained in the first step into a first plurality of subintervals based at least in part on the first plurality of transition probabilities. Each subinterval of the first plurality of subintervals corresponds to a respective transition probability of the first plurality of transition probabilities, and the length of each subinterval of the first plurality of subintervals is proportional to a respective transition probability of the first plurality of transition probabilities. For example, the subinterval corresponding to p₁(aᵢ) is

$$[ {Σ}_{κ = 0}^{i - 1} {p}_{1} ( {a}_{κ} ) , {Σ}_{κ = 0}^{i} {p}_{1} ( {a}_{κ} ) ) ,$$

and the length of this subinterval sorresponding to p₁(aᵢ) is

The wireless communication device may further identify a first subinterval of the second interval using the number x′ (equals x₀) and based at least in part on the first plurality of subintervals. The wireless communication device may determine that the number x₀ lies within the second interval in a portion that corresponds to the first subinterval. In other words, the number x₀ corresponds to a first transition probability to which the first subinterval also corresponds. The wireless communication device may identify a first energy transition value to which the first transition probability corresponds. The wireless communication device may select the first energy transition value and determine a first symbol s₁ of the output symbol sequence s to correspond to the first energy transition value.

The wireless communication device may further apply a scaling operation to the number x₀ according to Equation (50), thereby resulting in a second number x₁. Additionally, the wireless communication device may apply a scaling operation on the first subinterval, thereby generating a scaled first subinterval. The wireless communication device may update the residual length and the residual energy so that n₁=n−1 and E₁=E₀−E(s₁).

In some examples, in a subsequent iteration (e.g., t=1) in which n>1, the wireless communication device may access a second plurality of sequence quantities, e.g., N(n₁−1, E₁−E(aᵢ)). Each sequence quantity corresponds to a respective symbol in the symbol alphabet [symbol] ₘ. The wireless communication device may further determine a second plurality of transition probabilities based at least in part on the second plurality of sequence quantities and in accordance with Equation (48) or (52); for example,

$${p}_{2} ( {a}_{i} ) = \frac{N ( n - 1 , {E}_{1} - E ( {a}_{i} ) )}{N ( {n}_{1} , {E}_{1} )} . \qquad ( 55 )$$

Each transition probability of the second plurality of transition probabilities corresponds to a respective symbol in symbol alphabet [symbol] ₘ and each transition probability of the second plurality of transition probabilities is proportional to a respective sequence quantity of the second plurality of sequence quantities. For example, the transition probability p₂(aᵢ) corresponds to symbol aᵢ and p₂(aᵢ) is proportional to N(n₁−1,E₁−E(aᵢ)). The wireless communication device may partition the scaled first subinterval into a second plurality of subintervals based at least in part on the second plurality of transition probabilities. Each subinterval of the second plurality of subintervals corresponds to a respective transition probability of the second plurality of transition probabilities, and the length of each subinterval of the second plurality of subintervals is proportional to a respective transition probability of the second plurality of transition probabilities. For example, the subinterval corresponding to p₂(aᵢ) is

$$[ {Σ}_{κ = 0}^{i - 1} {p}_{2} ( {a}_{κ} ) , {Σ}_{κ = 0}^{i} {p}_{2} ( {a}_{κ} ) ) ,$$

and the length of this subinterval is equal to p₂(aᵢ).

The wireless communication device may further identify a second subinterval of the scaled first subinterval using the number x₁ and based at least in part on the second plurality of subintervals. The wireless communication device may determine that the number x₁ lies within the scaled first subinterval in a portion that corresponds to the second subinterval. In other words, the second number corresponds to a second transition probability to which the second subinterval also corresponds. The wireless communication device may identify a second energy transition value to which the second transition probability corresponds. The wireless communication device may select the second energy transition value and determine a second symbol s₂ of the output symbol sequence s to correspond to the second energy transition value. The wireless communication device may further apply a scaling operation to the number x₁ according to Equation (50), thereby resulting in a third number x₂. Additionally, the wireless communication device may apply a scaling operation on the second subinterval, thereby generating a scaled second subinterval. The wireless communication device may update the residual length and the residual energy so that n₂=n₁−1 and E₂=E₁−E(s₂). Further iterations may be performed (if any remain).

### Interval Representation of the Two-Step Energy-Based AC Encoding Method

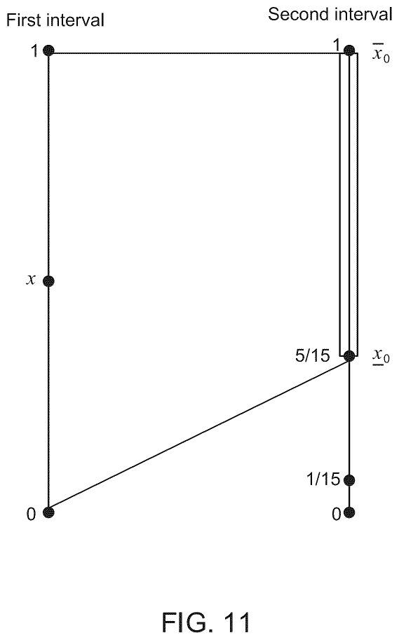

FIGS. 11-15 illustrate an example method for arithmetic coding using a two-step method according to one implementation. The example method of FIGS. 11-15 may be performed by a UE 115 or a BS 105 and, more specifically, by a wireless communication device, such as illustrated by FIG. 2 and implemented according to the examples of FIGS. 3-5. For instance, a processor or other logic device may execute firmware or software instructions to provide the functionality of the example method of FIGS. 11-15. It is understood that the scope of implementations is not limited to any specific number of iterations or maximum energy, and the number of iterations and maximum energy may be determined as appropriate for any particular application.

One way to view the two-step method is as an interval refinement technique. In one example, a unit interval [0, 1) refinement process can be associated to the two-step method. The first step of encoding corresponds to refining [0,1) to [x₀,x̅₀), where x₀ and x̅₀ are specified according to:

$${\underline{x}}_{0} = \frac{{N}_{c} ( n , E - 1 )}{{N}_{c} ( n , \overline{E} )} \qquad ( 56 )$$

$${\overline{x}}_{0} = \frac{{N}_{c} ( n , E )}{{N}_{c} ( n , \overline{E} )} \qquad ( 57 )$$

The second step corresponds to sequentially refining the interval [_x₀, x̅₀) refined from the first step to an interval [xₙ, x̅ₙ) in n iterations, i.e., [x₀, x̅₀) ⊇[x₁, x̅₁) ⊇[x₂, x̅₂) ⋅ . . . ⊇[xₙ, x̅ₙ)∈x; for a general t ∈ {0, 1, . . . , n−1}, the interval refinement is:

$${\underline{x}}_{t + 1} = {\underline{x}}_{t} + ( {\overline{x}}_{t} - {\underline{x}}_{t} ) {\sum }_{i = 1}^{{j}_{t + 1} - 1} {p}_{t + 1} ( {a}_{i} ) , \qquad ( 58 )$$

$${\underline{x}}_{t + 1} = {\underline{x}}_{t} + ( {\overline{x}}_{t} - {\underline{x}}_{t} ) {\sum }_{i = 1}^{{j}_{t + 1}} {p}_{t + 1} ( {a}_{i} ) . \qquad ( 59 )$$

The interval [xₜ, x̅ₜ) corresponds to the symbols determined during the first t iterations, i.e., the prefix (s₁, s₂, . . . , sₜ). In particular, the last interval corresponds to the output sequence, and it has length:

$$\vert [ {\underline{x}}_{n} , {\overline{x}}_{n} ) \vert = ( {\overline{x}}_{0} - {\underline{x}}_{0} ) {\prod }_{i = 1}^{n} {p}_{i} ( {s}_{i} ) = \frac{1}{{N}_{C} ( n , \overline{E} )} . \qquad ( 60 )$$

The length of the last interval [xₙ, x̅ₙ) therefore only depends on m, n and Ē through N_{c}(n, Ē).

Setup for the two-step method, in the example of FIGS. 11-15, includes the same alphabet, length, and energy at most E=6 as those given above with respect to the one-step method of FIGS. 6-9. For instance, m=3, and the symbol alphabet is given by [symbol] ₃={a₁, a₂, a₃} with an ordering< over the alphabet such that a₁< a₂< a₃. Symbol energies in this example are respectively: E(aᵢ)=1, E(a₂)=2 and E(a₃)=3.

The symbol sequences (over [symbol] ₃) have length n=4 and energy at most E=6. The set of all such sequences is denoted by [symbol] (3, 4, 6). Further, the largest k satisfying the input condition is k=3, i.e., 2⁻³≥1/15. The bit sequence (1, 0, 0) is the input, and the dyadic number corresponding to (1, 0, 0) is x=x₀=0.5.

FIG. 11 is an illustration of an example first step. There is a first interval from 0 to 1, and the first step sets the energy for encoding by defining a second interval. In the example of FIG. 11, there are 10 sequences each having length 4 and having an energy of 6, there are 4 sequences each having length 4 and having an energy of 5, and there are 1 sequence having length 4 and having an energy of 4. That gives a first plurality of ratios including 10/15, 4/15 and 1/15.

The first step of encoding selects the energy Ē of the output sequence, and it determines E by locating x in an interval of the form:

$$[ \frac{{N}_{c} ( 4 , E - 1 )}{{N}_{c} ( 4 , 6 )} , \frac{{N}_{c} ( 4 , E )}{{N}_{c} ( 4 , 6 )} ) . \qquad ( 61 )$$

The ranges of the first interval are set out as [0,1/15), [1/15, 5/15) and [5/15, 1). In this example, x equals 0.5, which falls in the range [5/15, 1), so that the wireless communication device selects the second interval, which corresponds to the range [5/15,1). In other words, the second interval corresponds to the set of symbol sequences in [symbol] (3, 4, 6) that have energy equal to 6. The length of this the second interval is proportional to the cardinality of this set, i.e., N_{c}(4, 6)−N_{c}(4, 5)=N(4, 6)=10. The iterations are then performed in the second interval [5/15, 1).

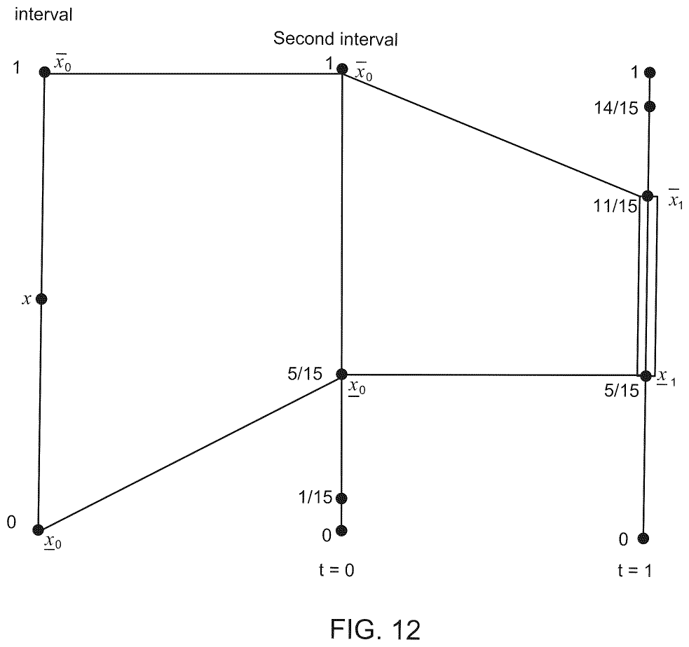

Then, x is scaled to x′=0.25. These initialize x₀=x′=0.25 and E₀=6 for the second step of encoding (FIG. 12). The energy selection step of FIG. 11 effectively partitions the unit interval into 3 subintervals. Each such subinterval corresponds to a set of all symbol sequences in [symbol] (3, 4, 6) that have a particular energy. The length of each such subinterval is proportional to the cardinality of the set that it corresponds to N_{c}(4, E−1) and counts all sequences having length 4 and energy at most E−1. The number N_{c}(4, E) counts all sequences having length 4 and energy at most E. Thus, the length of the subinterval of the stated form is proportional to N_{c}(4, E)−N_{c}(4,E−1)=N(4, E). The ordering of these subintervals corresponds to the ordering of the energies (i.e., 4<5<6).

FIG. 12 illustrates an example first iteration of the second step. The iterations in the two-step method are similar to the iterations in the one-step method of FIGS. 6-9. One difference between the two encoding methods is that the two-step method performs its iterations by calculating ratios with respect to N, whereas the one-step method performs its iterations by calculating ratios with respect to N_{c}. As described above, the sequence quantity N represents a number of sequences that are specific to a particular energy level. By contrast, N_{c} represents a number of sequences corresponding to a particular energy level or below.

The first iteration of the second step starts with x₀=0.25, n₀=4 and E₀=6 and evaluates sequence quantities N(3, 5)=6, N(3, 4)=3 and N(3, 3)=1. Ratios are then given by

$${p}_{1} ( {a}_{1} ) = \frac{N ( {n}_{0} - 1 , {E}_{0} - E ( {a}_{1} ) )}{N ( {n}_{0} , {E}_{0} )} = \frac{6}{10} , \qquad ( 62 )$$

$${p}_{1} ( {a}_{2} ) = \frac{N ( {n}_{0} - 1 , {E}_{0} - E ( {a}_{2} ) )}{N ( {n}_{0} , {E}_{0} )} = \frac{3}{10} , \qquad ( 63 )$$

$${p}_{1} ( {a}_{3} ) = \frac{N ( {n}_{0} - 1 , {E}_{0} - E ( {a}_{3} ) )}{N ( {n}_{0} , {E}_{0} )} = \frac{1}{10} . \qquad ( 64 )$$

Since x₀=0.25 E [0,6/10), the first iteration determines that j₁=1 and the first output symbol s₁=a₁. Then, the first iteration scales x₀ to x₁ according to:

$${x}_{1} = \frac{{x}_{0} - 0}{{p}_{1} ( {s}_{1} )} = \frac{5}{12} . \qquad ( 65 )$$

Then, the first iteration updates n₀ and E₀ respectively to n₁=n₀−1=3 and E₁=E₀−E(s₁)=5. Also, the first iteration increases t by 1 and t reaches 1. This sets up the second iteration of the second step.

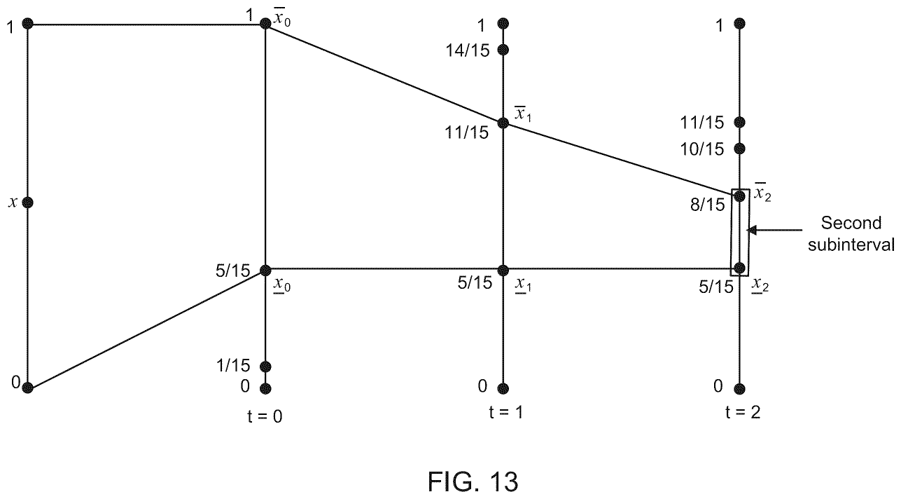

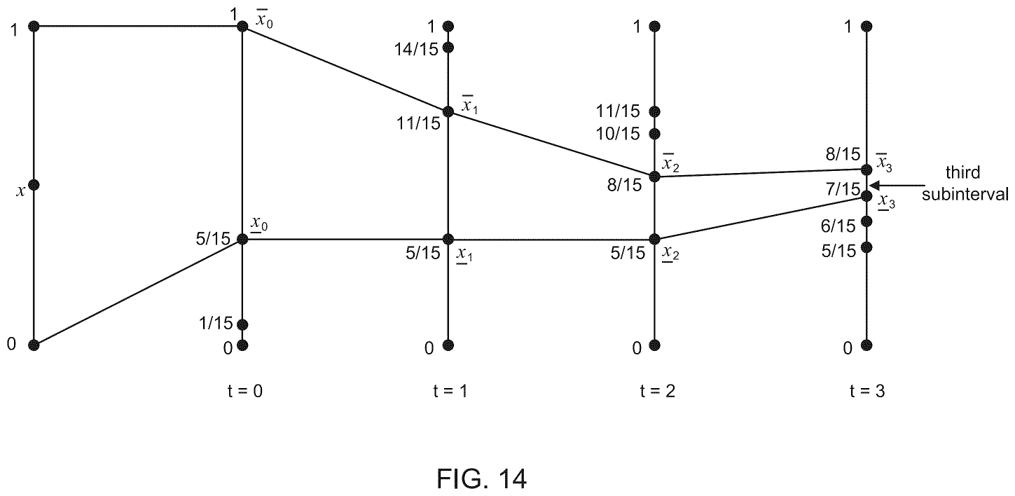

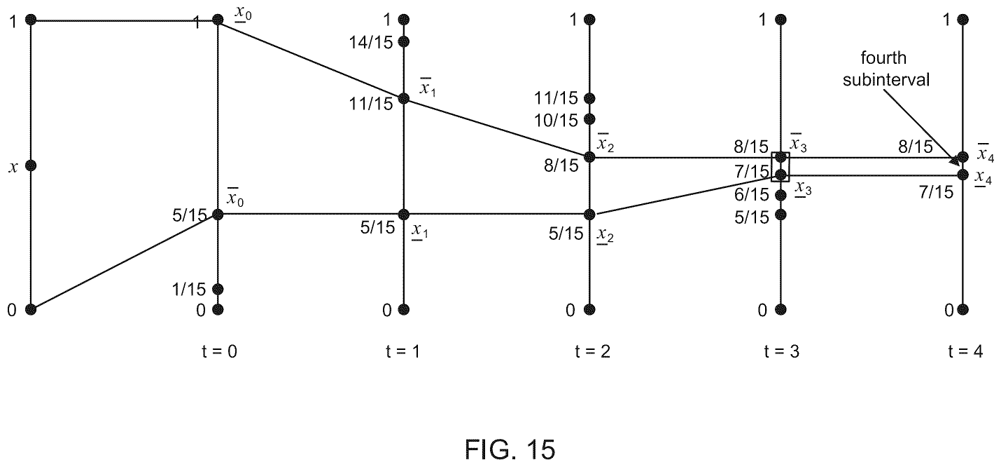

The wireless communication device performs the first iteration to define the first subinterval. The second iteration defines the second subinterval (FIG. 13), the third iteration defines the third subinterval (FIG. 14), and the fourth iteration defines the fourth subinterval (FIG. 15). Each of the iterations selects a respective amplitude symbol for the n-length sequence of amplitude symbols. In this example case, the sequence of amplitudes symbols is (s₁, s₂, s₃, s₄).

The second iteration of the second step takes x₁=5/12, n₁=3 and E₁=5; it evaluates sequence quantities N(2, 4)=3, N(2, 3)=2 and N(2, 2)=1. Ratios of the second iteration are then given by:

$${p}_{2} ( {a}_{1} ) = \frac{N ( {n}_{1} - 1 , {E}_{1} - E ( {a}_{1} ) )}{N ( {n}_{1} , {E}_{1} )} = \frac{3}{6} , \qquad ( 66 )$$

$${p}_{2} ( {a}_{2} ) = \frac{N ( {n}_{1} - 1 , {E}_{1} - E ( {a}_{2} ) )}{N ( {n}_{0} , {E}_{0} )} = \frac{2}{6} , \qquad ( 67 )$$

$${p}_{2} ( {a}_{3} ) = \frac{N ( {n}_{1} - 1 , {E}_{1} - E ( {a}_{3} ) )}{N ( {n}_{1} , {E}_{1} )} = \frac{1}{6} , \qquad ( 68 )$$

Since x₁ ∈[0, 3/6), the second iteration determines that j₂=1 and the second output symbol s₂=a₁. Then, the second iteration scales x₁ to x₂ according to:

$${x}_{2} = \frac{{x}_{1} - 0}{{p}_{2} ( {s}_{2} )} = \frac{5}{6} . \qquad ( 69 )$$

Then, the second iteration updates n₁ and E₁ respectively to n₂=n₁−1=2 and E₂=E₁−E(s₂)=4. Also, the second iteration increases t by 1 and t reaches 2. This sets up the third iteration, shown in FIG. 14.

The third iteration of the second step takes x₂=5/6, n₂=2 and E₂=4 and evaluates sequence quantities N(1, 3)=1, N(1, 2)=1 and N(1, 1)=1. Ratios of the third iteration are then given by:

$${p}_{3} ( {a}_{1} ) = \frac{N ( {n}_{1} - 1 , {E}_{2} - E ( {a}_{1} ) )}{N ( {n}_{1} , {E}_{1} )} = \frac{1}{3} , \qquad ( 70 )$$

$${p}_{3} ( {a}_{2} ) = \frac{N ( {n}_{2} - 1 , {E}_{2} - E ( {a}_{2} ) )}{N ( {n}_{2} , {E}_{2} )} = \frac{1}{3} , \qquad ( 71 )$$

$${p}_{3} ( {a}_{3} ) = \frac{N ( {n}_{2} - 1 , {E}_{2} - E ( {a}_{3} ) )}{N ( {n}_{2} , {E}_{2} )} = \frac{1}{3} , \qquad ( 72 )$$

Since x₂ E [2/3, 1), the encoding determines that j₃=3 and the second output symbol s₃=a₃. Then, it scales x₂ to x₃ according to:

$${x}_{3} = \frac{{x}_{2} - 2 / 3}{{p}_{3} ( {s}_{3} )} = \frac{1}{2} . \qquad ( 73 )$$

Then, the third iteration updates n₂ and E₂ respectively to n₃=n₂−1=1 and E₃=E₂−E(s₃)=1. Also, the third iteration increases t by 1 and t reaches 3. This sets up the fourth iteration, as shown in FIG. 15.

The fourth iteration of the second step takes x₃=1/2, n₃=1 and E₃=1 and evaluates sequence quantities N(0, 0)=1, N(0, −1)=0 and N(0, −2)=0. Ratios of the fourth iteration are then given by:

$${p}_{4} ( {a}_{1} ) = \frac{N ( {n}_{3} - 1 , {E}_{3} - E ( {a}_{1} ) )}{N ( {n}_{1} , {E}_{1} )} = 1 , \qquad ( 74 )$$

$${p}_{4} ( {a}_{2} ) = \frac{N ( {n}_{3} - 1 , {E}_{3} - E ( {a}_{2} ) )}{N ( {n}_{3} , {E}_{3} )} = 0 , \qquad ( 75 )$$

$${p}_{4} ( {a}_{3} ) = \frac{N ( {n}_{3} - 1 , {E}_{3} - E ( {a}_{3} ) )}{N ( {n}_{3} , {E}_{3} )} = 0 , \qquad ( 76 )$$

The fourth iteration determines that j₄=1 and the second output symbol s₄=a₁. Then, the fourth iteration scales x₃ to x₄ according to:

$${x}_{4} = \frac{{x}_{3} - 0}{{p}_{4} ( {s}_{4} )} = \frac{1}{2} . \qquad ( 77 )$$

Then, the fourth iteration updates n₃ and E₃ respectively to n₄=n₃−1=0 and E₄=E₃−E(s₄)=0, and the fourth iteration increases t by 1 and t reaches 4; the second step finishes at this point.

### Graphical Representation of the Two-Step Energy-Based AC Encoding Method

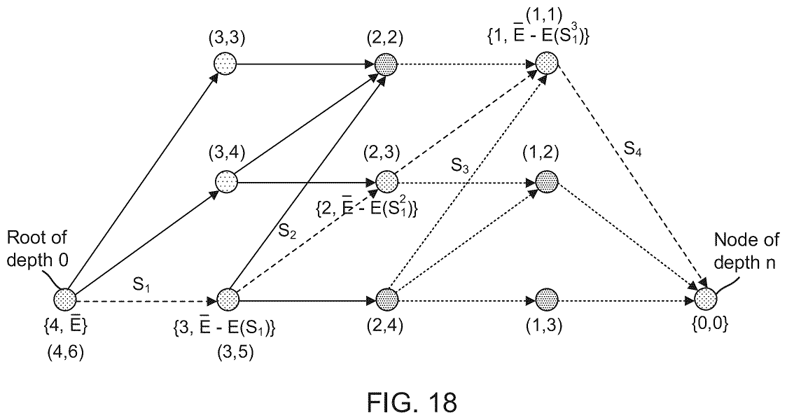

Another way to represent the two-step method described above is with a graphical representation, such as shown in FIG. 18. The example of FIG. 18 has n=4 for simplicity, just as in FIGS. 11-15. FIG. 18 illustrates the rooted graph with directed edges that can be associated with the second step of the two-step method. The root is of depth 0 and corresponds to {n, E}representing the set of all sequences over [symbol] ₘ with each sequence having length n and energy equal to E.

A generic node of depth t≤n corresponds to (e.g., is labelled by)

$$\{ n = t , E - E ( {S}_{1}^{t} ) \} .$$

Such a node represents the set of all sequences over [symbol] ₘ with each sequence having length n−t and energy equal to

$$E - E ( {s}_{1}^{t} ) .$$

### Here,

$${s}_{1}^{t} = ( {s}_{1} , {s}_{2} , … , {s}_{t} )$$

is the prefix of a symbol sequence s ∈ [symbol] (m, n, Ē) that has energy equal to E. The cardinality of the set

$$\{ n - t , E - E ( {s}_{1}^{t} ) \} is N ( n - t , E - E ( {s}_{1}^{t} ) ) .$$

A directed edge from a node of depth t is of the form:

$$\{ n - t , E - E ( {s}_{1}^{t} ) \} \to \{ n - t - 1 , E - E ( {s}_{1}^{t + 1} ) \} . \qquad ( 78 )$$

In Equation (78),

$${s}_{1}^{t} = ( {s}_{1} , {s}_{2} , … , {s}_{t} ) and {s}_{1}^{t + 1} = ( {s}_{1} , {s}_{2} , … , {s}_{t} , {s}_{t + 1} )$$

are the prefixes of a symbol sequence s ∈ [symbol] (m, n, Ē) that has energy E. A path from the root to a node of depth n gives rise to a symbol sequence in [symbol] (m, n, Ē).

Since the energies E(aᵢ) are assumed distinct, parent-to-child relation of connected nodes represents a disjoint union. All paths end up with node {0, 0} of depth n, and the total number of distinct paths is equal to the N(n, E) sequence quantity, which is the number of all sequences in [symbol] (m, n, Ē) that has energy equal to E. The node

$$\{ n - t , E - E ( {s}_{1}^{t} ) \}$$

of depth t≤n corresponds to the second step of encoding after t iterations, where

$${s}_{1}^{t}$$

shas been determined so that the number of symbols still to be determined is n−t and the total amount of energy available is

$$E - E ( {s}_{1}^{t} )$$

This means that n−t corresponds to the residual length and

$$E - E ( {s}_{1}^{t} )$$

corresponds to the residual energy before symbol sₜ₊₁ is determined.

In the second step of encoding and for a generic t ∈ {0, 1, . . . , n−1}, the determination of symbol sₜ₊₁ corresponds to the transition from a (parent) node of depth t to a (child) node of depth t+1. Each pₜ₊₁(aᵢ) can be interpreted as a transition probability from node

$$\{ n - t , E - E ( {s}_{1}^{t} ) \}$$

to node

$$\{ n - t - 1 , E - E ( {s}_{1}^{t} ) - E ( {a}_{i} ) \}$$

as shown by the following relation:

$${p}_{t + 1} ( {a}_{i} ) = \frac{N ( n - t - 1 , E ( {s}_{1}^{t} ) - E ( {a}_{i} ) )}{N ( n - t , E - E ( {s}_{1}^{t} ) )} = \frac{N ( {n}_{t} - 1 , {E}_{t} - E ( {a}_{i} ) )}{N ( {n}_{t} , {E}_{t} )} . \qquad ( 79 )$$

Each iteration of the second step determines an amplitude symbol. The symbols are determined iteratively using the dyadic number x and the ratios, which represent transition probabilities. Starting with the root of depth 0, the first iteration determines s₁ by determining that x corresponds to a ratio associated with s₁. The energy Ē and length n are then decremented, the ratios calculated again, and s₂ is determined by determining that the number x corresponds to a ratio associated with s₂. Two more iterations are then performed, decrementing n all the way to 0. Just as in the example of FIGS. 11-15, the sequence of amplitudes values is (s₁, s₂, s₃, s₄), and this is shown by the progression from the root to the node of depth n in FIG. 18.

### The Two-Step Energy-Based AC Encoding Method

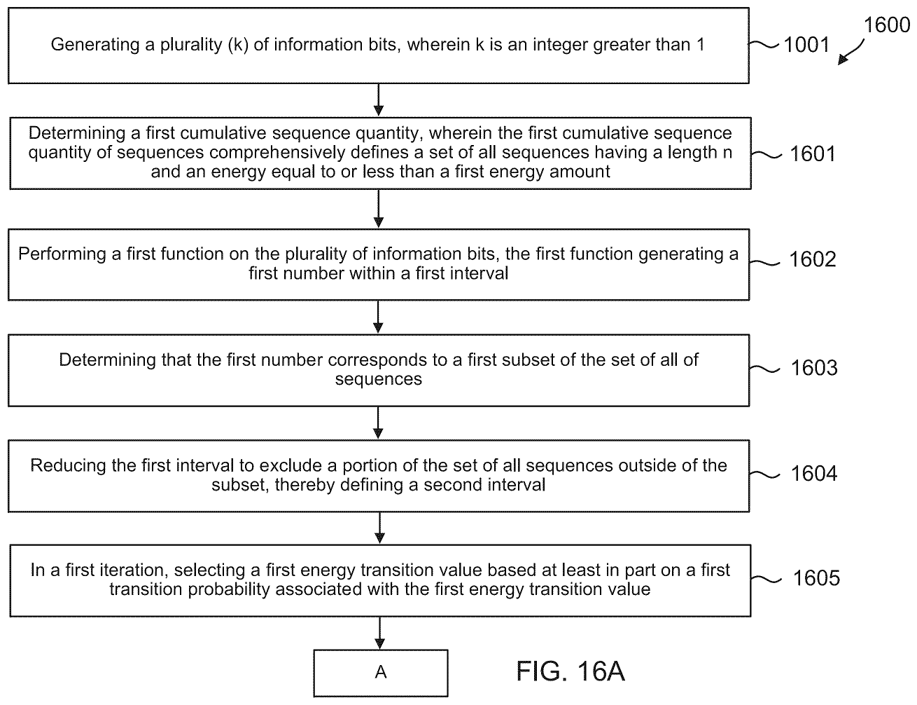

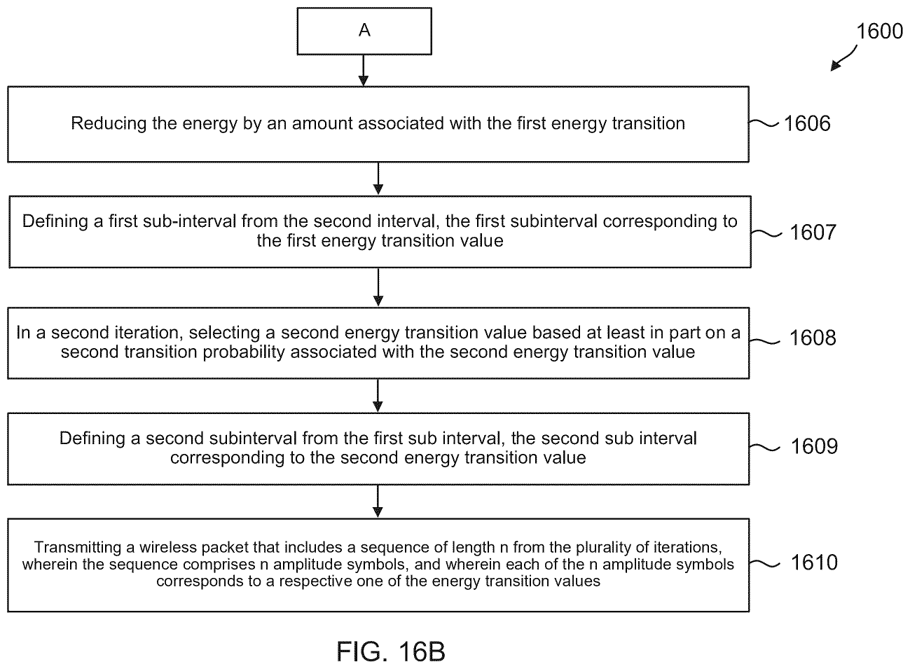

FIGS. 16A and 16B present an illustration of example method 1600, which is a way of illustrating the two-step method. The two-step method may be performed by a UE 115 or a BS 105 and, more specifically, by a wireless communication device, such as illustrated by FIG. 2 and implemented according to the examples of FIGS. 3-5.

Action 1601 is the same as or similar to action 1001 in FIG. 10A.

Actions 1601-1604 describe the first step of the two-step method, as in FIG. 11. At action 1601, the wireless communication device determines a first quantity of sequences. In this example, the first quantity of sequences comprehensively defines a set of all sequences having a length n and an energy equal to or less than a first energy amount, an example being a plurality of N_{c} cumulative sequence quantities.

At action 1602, the wireless communication device performs a first function on the plurality of information bits. In this example, the first function generates a first number within a first interval. For instance, the first function may be a dyadic number function, which generates x, and an example of the first interval [0, 1), though any appropriate interval may be used.

At action 1603, the wireless communication device determines that the first number corresponds to a first subset of the set of all sequences. For instance, the wireless communication device computes ratios based on these N_{c} cumulative sequence quantities such that each such ratio is proportional to an N_{c} cumulative sequence quantity and then determines which ratio corresponds to x. Action 1604 includes the wireless communication device reducing the first interval to exclude a portion of the set of all sequences outside of the first subset. Action 1604 defines a second interval. The result of actions 1601-1604 is that the wireless communication device determines the energy of the output sequence.

At action 1605, the wireless communication device performs a first iteration of the second step of the two-step method. The iterations are similar to the iterations described above with respect to one-step method of FIGS. 6-9, but the iterations in the two-step method calculate transition probabilities using the N sequence quantities, rather than N_{c} cumulative sequence quantities. As noted above, the N sequence quantities describe the cardinality of a set of sequences specific to an energy, whereas the N_{c} cumulative sequence quantities describe the cardinality of a set of sequences specific to an energy and below that energy.

The first iteration includes selecting a first energy transition value based at least in part on a first transition probability associated with the first energy transition values. For example, the wireless communication device may compare the energy transition probabilities to an updated value of x and determine which one of the ratios corresponds to the updated value of x. Action 1606 includes the wireless communication device then reducing the energy by an amount associated with the first energy transition value, and action 1607 includes defining a first subinterval from the second interval, the first subinterval corresponding to the first energy transition value.

At action 1608, the wireless communication device performs a second iteration. The second iteration selects a second energy transition value based at least in part on a second transition probability associated with the second energy transition value. The second iteration is performed similarly to the first iteration, wherein ratios based on an N value of remaining sequences are calculated and then compared to a value. The value may include a further updated x. The ratio that corresponds to the value is then selected and used to define a second subinterval at action 1609.

The wireless communication device may continue to perform iterations until a number n of iterations is reached. Each of the iterations generates one of the amplitude symbols, and collectively the iterations generate a sequence of length n. The sequence includes n amplitude symbols, where each of the amplitude symbols corresponds to a respective one of the energy transition values. For example, each of the E(a) energy transition values selected at the iterations corresponds to an amplitude symbol (a), which is then assigned as an (s) value in the sequence. Action 1610 is the same as or similar to action 1008 of FIG. 10B.

### Decoding

Wireless communication devices that transmit encoded data may also receive and decode encoded data. Decoding may be performed by a UE 115 or a BS 105 and, more specifically, by a wireless communication device, such as illustrated by FIG. 2 and implemented according to the examples of FIGS. 3-5.

For instance, some examples assume that a receiving device has access to n, alphabet [symbol] ₘ and maximum energy Ē. The wireless communication device also has the n amplitude symbols as well. The decoding operation for the one-step method includes accessing the N_{c} cumulative sequence quantities for each possible energy and then computing the ratios using those N_{c} cumulative sequence quantities. The wireless communication device then reconstructs the subintervals one at a time from the first subinterval (e.g., as in FIG. 6) to a last subinterval (e.g., as in FIG. 9). Once the range of the last subinterval is known, the wireless communication device may then calculate a binary expansion of the upper limit of the range or of the lower limit of the range and use at least some of the bits of the binary expansion as an approximation of the k bits.

The following is an example of decoding when the one-step method has been used. A decoding operation based on the one-step method initializes t=0, nₜ=n, Eₜ=Ē and x₀=0, x̅₀=1. The decoding operation iterates the following until (and including) t=n−1.

An iteration t accesses N_{c}(nₜ−1, Eₜ−E(aᵢ)) for each i ∈{1, 2, . . . ,m} accesses N_{c}(nₜ, Eₜ), and computes the ratios, which represent transition probabilities:

$${p}_{t + 1} ( {a}_{i} ) = \frac{{N}_{c} ( {n}_{t} - 1 , {E}_{t} - E ( {a}_{i} ) )}{{N}_{c} ( {n}_{t} , {E}_{t} )} . \qquad ( 80 )$$

The iteration t then determines j=jₜ₊₁∈ {1, 2, . . . , m} such that aⱼ=sₜ₊₁ and then computes:

$${\underline{x}}_{t + 1} = {\underline{x}}_{t} + ( {\overline{x}}_{t} - {\underline{x}}_{t} ) {\sum }_{i = 1}^{{j}_{t + 1} - 1} {p}_{t + 1} ( {a}_{i} ) , \qquad ( 81 )$$

$${\overline{x}}_{t + 1} = {\underline{x}}_{t} + ( {\overline{x}}_{t} - {\underline{x}}_{t} ) {\sum }_{i = 1}^{{j}_{t + 1}} {p}_{t + 1} ( {a}_{i} ) . \qquad ( 82 )$$

The iteration t further computes nₜ₊₁=nₜ−1 and Eₜ₊₁=Eₜ−E(sₜ₊₁) and then increases t by 1, and this completes iteration t.

The decoding operation outputs ( [symbol] , [symbol] , . . . , [symbol] ) as follows. If x̅ₙ is not a dyadic number of the form j2^{-k}, it takes the first k bits of the binary expansion of x̅ₙ as the decoded output. Otherwise, the decoding operation takes the first k bits of the binary expansion of xₙ as the decoded output.

The decoding operation associated with information that has been encoded using the two-step method is similar. Once again, the receiving wireless communication device has access to n, alphabet [symbol] ₘ and maximum energy Ē. The wireless communication device also has the n amplitude symbols. The wireless communication device first obtains the energy Ē of the sequence and then calculates the N_{c} cumulative sequence quantities for each possible energy. The wireless communication device may then calculate ratios for various N_{c} cumulative sequence quantities to access the lower limit of the second interval (e.g., as in FIG. 11) and the upper limit of the second interval. Once the energy Ē and the upper and lower limit of the second interval have been obtained, then the wireless communication device may begin reconstructing the subintervals. For instance, the wireless communication device may access the N sequence quantities, compute the transition probabilities, and then reconstruct the subintervals from the first subinterval (e.g., as in FIG. 12) to the last subinterval (e.g., as in FIG. 15). Once the range of the last subinterval is known, the wireless communication device may then calculate a binary expansion of the upper limit of the range or of the lower limit of the range and use at least some of the bits of the binary expansion as an approximation of the k bits.

The following is an example of decoding information that has been encoded using the two-step method. Based on the sequence s=(s₁, s₂, . . . , sₙ), the first step of decoding obtains the energy Ē of the sequence s according to:

$$E = E ( s ) = {\sum }_{l = 1}^{n} E ( {s}_{l} ) . \qquad ( 83 )$$

Then, the wireless communication device computes x₀ and x̅₀ according to:

$${\underline{x}}_{0} = \frac{{N}_{c} ( n , E - 1 )}{{N}_{c} ( n , \overline{E} )} , \qquad ( 84 )$$

$${\overline{x}}_{0} = \frac{{N}_{c} ( n , E )}{{N}_{c} ( n , \overline{E} )} . \qquad ( 85 )$$

The energy Ē, x₀ and x̅₀ are subsequently used in the second step of decoding. More precisely, the second step of decoding initializes t=0, nₜ=n, Eₜ=E, and uses x₀ and x̅₀ as the initialization for the iterations.

Like encoding, the N(n, [symbol] ) sequence quantities and N_{c}(n, [symbol] ) cumulative sequence quantities for general n and (used in the decoding can be accessed by the following ways: computed exactly and directly, e.g., using the recursive definition, accessed in a look-up table storing such values, approximated by an approximation method.

A given operation of the decoding based on the two-step method iterates the following until (and including) t=n−1. The iteration t accesses N(nₜ−1, Eₜ−E(aᵢ)) for each i ∈{1, 2, . . . , m} and accesses N(nₜ, Eₜ). The iteration t computes the ratios, which represent transition probabilities as shown:

$${p}_{t + 1} ( {a}_{i} ) = \frac{N ( {n}_{t} - 1 , {E}_{t} - E ( {a}_{i} ) )}{N ( {n}_{t} , {E}_{t} )} . \qquad ( 86 )$$

The iteration t determines j=jₜ₊₁ ∈ {1, 2, . . . , m} such that a₁=sₜ₊₁ and then computes:

$${\underline{x}}_{t + 1} = {\underline{x}}_{t} + ( {\overline{x}}_{t} - {\underline{x}}_{t} ) {\sum }_{i = 1}^{{j}_{t + 1} - 1} {p}_{t + 1} ( {a}_{i} ) , \qquad ( 87 )$$

$${\overline{x}}_{t + 1} = {\underline{x}}_{t} + ( {\overline{x}}_{t} - {\underline{x}}_{t} ) {\sum }_{i = 1}^{{j}_{t + 1}} {p}_{t + 1} ( {a}_{i} ) . \qquad ( 88 )$$

The iteration t then computes nₜ₊₁=nₜ−1 and Eₜ₊₁=Eₜ−E(sₜ₊₁), increases t by 1, and this completes the iteration t.

The process of decoding information that has been encoded using the two-step method then outputs ( [symbol] , [symbol] , . . . , [symbol] ) as follows: If x̅ₙ is not a dyadic number of the form j₂^{-k}, it takes the first k bits of the binary expansion of x̅ₙ as the decoded output. Otherwise, it takes the first k bits of the binary expansion of x̅ₙ as the decoded output.

### CLAUSES

Various implementations may be described by the following numbered clauses:
1. A method for wireless communication by a wireless communication device, the method comprising:
   generating a plurality (k) of information bits, wherein k is an integer greater than 1;
   performing an encoding operation on the plurality of information bits, the encoding operation having a maximum energy for amplitude modulation of the plurality of information bits, the encoding operation being performed in a plurality of iterations and including:
      in a first iteration, selecting a first energy transition value based at least in part on a first transition probability associated with the first energy transition value, wherein the maximum energy corresponds to a first interval;
      reducing the maximum energy by an amount associated with the first energy transition value;
      defining a first subinterval from the first interval, the first subinterval corresponding to the first energy transition value;
      in a second iteration, selecting a second energy transition value based at least in part on a second transition probability associated with the second energy transition value; and
      defining a second subinterval from the first subinterval, the second subinterval corresponding to the second energy transition value;
   transmitting a wireless packet to at least one receiving device based on a first sequence, wherein the first sequence is generated from the plurality of iterations and has n amplitude symbols, where n is equal to a total quantity of the plurality of iterations, and wherein each of the n amplitude symbols corresponds to a respective energy transition value of a plurality of energy transition values.
2. The method of clause 1, wherein the encoding operation and the transmitting is performed by a user equipment (UE).
3. The method of clause 1, wherein the encoding operation and the transmitting is performed by a wireless base station (BS).
4. The method of any of clauses 1-3, wherein each of the n amplitude symbols is selected from an alphabet of size m, the alphabet defining a set of different energy transition values, wherein m is an integer greater than 1.
5. The method of any of clauses 1-4, wherein selecting the first energy transition value comprises:
   performing a first function on the plurality of information bits, the first function generating a first number within the first interval; and
   determining that the first number lies within the first interval in a first portion that corresponds to the first energy transition value.
6. The method of clause 5, wherein the first number comprises a dyadic number.
7. The method of clause 5, wherein selecting the second energy transition value comprises:
   applying a scaling operation on the first subinterval, thereby generating a scaled first subinterval; and
   determining that a second number lies within the scaled first subinterval in a second portion that corresponds to the second energy transition value.
8. The method of any of clauses 1-7, further comprising:
   determining a first cumulative sequence quantity, wherein the first cumulative sequence quantity defines a set of all sequences having a length n and an energy equal to or less than the maximum energy and belonging to an alphabet; and
   wherein the first energy transition value is selected from a group of energy transition values representing all possible energy transition values within the alphabet, which has size m of energy transition values, wherein m is an integer greater than 1.
9. The method of clause 8, wherein selecting the first energy transition value comprises:
   calculating a plurality of ratios, each one of the ratios being proportional to a respective quantity of sequences, wherein each one of the respective quantity of sequences comprehensively defines a set of all sequences having a length n minus 1 and an energy equal to or less than the maximum energy minus an energy of a respective symbol in the alphabet;
   performing a first function on the plurality of information bits; and
   identifying that a first ratio corresponding to the first energy transition value corresponds to a value generated by the first function.
10. The method of clause 8, wherein the n amplitude symbols of the first sequence correspond to n energy transition values, and the alphabet defines a set of different energy transition values.
11. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to:
generate a plurality (k) of information bits, wherein k is an integer greater than 1;
perform an encoding operation on the plurality of information bits, the encoding operation having a plurality of iterations and including:
   determine a first cumulative sequence quantity, wherein the first cumulative sequence quantity defines a set of all sequences having a length n and an energy equal to or less than a first energy amount and belonging to an alphabet;
   perform a first function on the plurality of information bits, the first function generating a first number within a first interval;
   determine that the first number corresponds to a first subset of the set of all sequences; and
   reduce the first interval to exclude a portion of the set of all sequences outside of the first subset, thereby defining a second interval and, wherein the second interval corresponds to an energy for amplitude modulation of the plurality of information bits;
   in a first iteration, select a first energy transition value based at least in part on a first transition probability associated with the first energy transition value;
   reduce the energy for amplitude modulation by an amount associated with the first energy transition value;
   define a first subinterval from the second interval, the first subinterval corresponding to the first energy transition value;
   in a second iteration, select a second energy transition value based at least in part on a second transition probability associated with the second energy transition value; and
   define a second subinterval from the first subinterval, the second subinterval corresponding to the second energy transition value;
transmit a wireless packet to at least one receiving device based on a first sequence, wherein the first sequence is generated from the plurality of iterations and has n amplitude symbols from the plurality of iterations, where n is equal to a total quantity of the plurality of iterations, and wherein each of the n amplitude symbols corresponds to a respective energy transition value of a plurality of energy transition values.
12. The wireless communication device of clause 11, wherein the processor-readable code to cause the wireless communication device to select the first energy transition value comprises processor-readable code to cause the wireless communication device to:
   calculate a plurality of ratios, each one of the ratios being proportional to a respective quantity of sequences, wherein each one of the respective quantity of sequences comprehensively defines a set of all sequences having a length n minus 1 and an energy equal to the energy for amplitude modulation minus an energy of a respective symbol in the alphabet;
   perform a second function on the plurality of information bits to generate a second number; and
   identify that a first ratio corresponding to the first energy transition value corresponds to the second number generated by the second function.
13. The wireless communication device of clause 11, included within a user equipment (UE).
14. The wireless communication device of clause 11, included within a wireless base station (BS).
15. The wireless communication device of any of clauses 11-14, wherein the first sequence corresponds to a binary expansion of the plurality of information bits, and wherein the first sequence corresponds to a final subinterval of the plurality of iterations.
16. The wireless communication device of any of clauses 11-15, wherein a medium access control (MAC) layer of the wireless communication device is configured to generate the plurality of information bits.
17. The wireless communication device of any of clauses 11-16, wherein a physical (PHY) layer of the wireless communication device is configured to perform the encoding operation.
18. A non-transitory computer-readable medium having program code recorded thereon for wireless communication by a wireless communication device, the program code comprising:
   code for generating a plurality (k) of information bits, wherein k is an integer greater than 1;
   code for performing an encoding operation on the plurality of information bits, the encoding operation having a maximum energy for amplitude modulation of the plurality of information bits, the encoding operation being performed in a plurality of iterations and including:
      with each iteration of the plurality of iterations, selecting an amplitude symbol based upon a plurality of transition probabilities and constrained by a residual energy and a residual sequence length; and
   code for transmitting a wireless packet to at least one receiving device based on the a first sequence, wherein the first sequence is generated from the plurality of iterations and has n amplitude symbols from the plurality of iterations, where n is equal to a quantity of the plurality of iterations.
19. The non-transitory computer-readable medium of clause 18, wherein each of the n amplitude symbols is selected from an alphabet of size m, the alphabet defining a set of different energy transition values, wherein m is an integer greater than 1.
20. The non-transitory computer-readable medium of any of clauses 18-19, comprising code for selecting a first amplitude symbol of the n amplitude symbols during a first iteration of the plurality of iterations including:
   code for performing a first function on the plurality of information bits, the first function generating a first number within a first interval; and
   code for determining that the first number corresponds to a first energy transition value, the first energy transition value being associated with the first amplitude symbol.
21. The non-transitory computer-readable medium of clause 20, wherein the first number comprises a dyadic number.
22. The non-transitory computer-readable medium of any of clauses 18-21, comprising code for selecting a second amplitude symbol of the n amplitude symbols during a second iteration of the plurality of iterations including:
   scaling the first number, thereby generating a second number; and
   determining that the second number corresponds to a second energy transition value, the second energy transition value being associated with the second amplitude symbol.
23. The non-transitory computer-readable medium of any of clauses 18-22, further comprising:
   code for determining a first cumulative sequence quantity, wherein the first cumulative sequence quantity defines a set of all sequences having a length n and an energy equal to or less than the maximum energy and belonging to an alphabet; and
   wherein a first amplitude symbol is selected from a group of amplitude symbols representing all possible amplitude symbols within the alphabet, which has size m, wherein m is an integer greater than 1.
24. The non-transitory computer-readable medium of any of clauses 18-23 further comprising:
   code for receiving a subsequent wireless packet from a transmitting wireless communication device, the subsequent wireless packet including information having a second sequence of n symbols and an energy equal to or less than the maximum energy and defined by an alphabet;
   code for decoding the subsequent wireless packet, wherein decoding comprises: accessing a first number equal to a cumulative sequence quantity of sequences having energy equal to or less than the maximum energy, iteratively computing a plurality of transition probability ratios and with each decoding iteration reducing the first number to correspond to a residual decoding energy and a residual decoding length, further with each decoding iteration determining a decoding interval corresponding to the residual decoding energy, and after n decoding iterations generating a binary expansion corresponding to a final decoding interval.
25. A wireless communication device configured to perform an encoding operation on a plurality (k) of information bits, the wireless communication device comprising:
   means for determining a first energy of an output sequence, the first energy of the output sequence being between zero and a defined maximum energy;
   means for performing a plurality of encoding iterations, each one of the encoding iterations selecting an amplitude symbol based upon a plurality of transition probabilities and constrained by a residual energy and a residual sequence length; and
   means for transmitting a wireless packet to at least one receiving device based on the output sequence, wherein the output sequence is generated from the plurality of encoding iterations and has n amplitude symbols from the plurality of encoding iterations, where n is equal to a quantity of the plurality of encoding iterations, and wherein the output sequence has the first energy.
26. The wireless communication device of clause 25, wherein the means for determining the first energy of the output sequence comprises:
   means for determining a first cumulative sequence quantity, wherein the first cumulative sequence quantity defines a set of all sequences having a length n and an energy equal to or less than the defined maximum energy and belonging to a same alphabet;
   means for performing a first function on the plurality of information bits, the first function generating a first number within a first interval; and
   means for determining that the first number corresponds to a first subset of the set of all sequences.
27. The wireless communication device of clause 26, further comprising:
   means for reducing the first interval to exclude a portion of the set of all sequences outside of the first subset.
28. The wireless communication device of any of clauses 25-27, wherein the means for performing the plurality of encoding iterations comprises:
   means for, in a first iteration, selecting a first energy transition value based at least in part on a first transition probability associated with the first energy transition value;
   means for reducing the first energy by an amount associated with the first energy transition value; and
   means for defining a first subinterval from an interval corresponding to the first energy, the first subinterval corresponding to the first energy transition value.
29. The wireless communication device of clause 28, further comprising:
   means for, in a second iteration, selecting a second energy transition value based at least in part on a second transition probability associated with the second energy transition value; and
   means for defining a second subinterval from the first subinterval, the second subinterval corresponding to the second energy transition value.
30. The wireless communication device of any of clauses 25-29, further comprising:
   means for receiving a subsequent wireless packet from a transmitting wireless communication device, the subsequent wireless packet including information having a second sequence of n symbols and an energy equal to or less than the defined maximum energy and defined by an alphabet;
   means for decoding the subsequent wireless packet, wherein decoding comprises: computing a second energy of the second sequence of n symbols, accessing a first number equal to a cumulative sequence quantity of all sequences having energy equal to or less than the second energy, determining a first decoding interval corresponding to the second energy based at least in part upon a plurality of ratios using the first number, iteratively computing a plurality of transition probability ratios and with each decoding iteration reducing the second energy to correspond to a residual decoding energy, further with each decoding iteration determining a decoding subinterval corresponding to the residual decoding energy, and after n decoding iterations generating a binary expansion corresponding to a final decoding interval.

As used herein, “of” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the examples of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication by a wireless communication device, the method comprising:
generating a plurality (k) of information bits, wherein k is an integer greater than 1;
performing an encoding operation on the plurality of information bits, the encoding operation having a maximum energy for amplitude modulation of the plurality of information bits, the encoding operation being performed in a plurality of iterations and including:
in a first iteration, selecting a first energy transition value based at least in part on a first transition probability associated with the first energy transition value, wherein the maximum energy corresponds to a first interval;
reducing the maximum energy by an amount associated with the first energy transition value;
defining a first subinterval from the first interval, the first subinterval corresponding to the first energy transition value;
in a second iteration, selecting a second energy transition value based at least in part on a second transition probability associated with the second energy transition value; and
defining a second subinterval from the first subinterval, the second subinterval corresponding to the second energy transition value;
transmitting a wireless packet to at least one receiving device based on a first sequence, wherein the first sequence is generated from the plurality of iterations and has n amplitude symbols, where n is equal to a total quantity of the plurality of iterations, and wherein each of the n amplitude symbols corresponds to a respective energy transition value of a plurality of energy transition values.

2. The method of claim 1, wherein the encoding operation and the transmitting is performed by a user equipment (UE).

3. The method of claim 1, wherein the encoding operation and the transmitting is performed by a wireless base station (BS).

4. The method of claim 1, wherein each of the n amplitude symbols is selected from an alphabet of size m, the alphabet defining a set of different energy transition values, wherein m is an integer greater than 1.

5. The method of claim 1, wherein selecting the first energy transition value comprises:
performing a first function on the plurality of information bits, the first function generating a first number within the first interval; and
determining that the first number lies within the first interval in a first portion that corresponds to the first energy transition value.

6. The method of claim 5, wherein the first number comprises a dyadic number.

7. The method of claim 5, wherein selecting the second energy transition value comprises:
applying a scaling operation on the first subinterval, thereby generating a scaled first subinterval; and
determining that a second number lies within the scaled first subinterval in a second portion that corresponds to the second energy transition value.

8. The method of claim 1, further comprising:
determining a first cumulative sequence quantity, wherein the first cumulative sequence quantity defines a set of all sequences having a length n and an energy equal to or less than the maximum energy and belonging to an alphabet; and
wherein the first energy transition value is selected from a group of energy transition values representing all possible energy transition values within the alphabet, which has size m of energy transition values, wherein m is an integer greater than 1.

9. The method of claim 8, wherein selecting the first energy transition value comprises:
calculating a plurality of ratios, each one of the ratios being proportional to a respective quantity of sequences, wherein each one of the respective quantity of sequences comprehensively defines a set of all sequences having a length n minus 1 and an energy equal to or less than the maximum energy minus an energy of a respective symbol in the alphabet;
performing a first function on the plurality of information bits; and
identifying that a first ratio corresponding to the first energy transition value corresponds to a value generated by the first function.

10. The method of claim 8, wherein the n amplitude symbols of the first sequence correspond to n energy transition values, and the alphabet defines a set of different energy transition values.

11. A wireless communication device comprising:
at least one modem;
at least one processor communicatively coupled with the at least one modem; and
at least one memory communicatively coupled with the at least one processor and storing processor-readable code that, when executed by the at least one processor in conjunction with the at least one modem, is configured to:
generate a plurality (k) of information bits, wherein k is an integer greater than 1;
perform an encoding operation on the plurality of information bits, the encoding operation having a plurality of iterations and including:
determine a first cumulative sequence quantity, wherein the first cumulative sequence quantity defines a set of all sequences having a length n and an energy equal to or less than a first energy amount and belonging to an alphabet;
perform a first function on the plurality of information bits, the first function generating a first number within a first interval;
determine that the first number corresponds to a first subset of the set of all sequences; and
reduce the first interval to exclude a portion of the set of all sequences outside of the first subset, thereby defining a second interval and, wherein the second interval corresponds to an energy for amplitude modulation of the plurality of information bits;
in a first iteration, select a first energy transition value based at least in part on a first transition probability associated with the first energy transition value;
reduce the energy for amplitude modulation by an amount associated with the first energy transition value;
define a first subinterval from the second interval, the first subinterval corresponding to the first energy transition value;
in a second iteration, select a second energy transition value based at least in part on a second transition probability associated with the second energy transition value; and
define a second subinterval from the first subinterval, the second subinterval corresponding to the second energy transition value;
transmit a wireless packet to at least one receiving device based on a first sequence, wherein the first sequence is generated from the plurality of iterations and has n amplitude symbols from the plurality of iterations, where n is equal to a total quantity of the plurality of iterations, and wherein each of the n amplitude symbols corresponds to a respective energy transition value of a plurality of energy transition values.

12. The wireless communication device of claim 11, wherein the processor-readable code to cause the wireless communication device to select the first energy transition value comprises processor-readable code to cause the wireless communication device to:
calculate a plurality of ratios, each one of the ratios being proportional to a respective quantity of sequences, wherein each one of the respective quantity of sequences comprehensively defines a set of all sequences having a length n minus 1 and an energy equal to the energy for amplitude modulation minus an energy of a respective symbol in the alphabet;
perform a second function on the plurality of information bits to generate a second number; and
identify that a first ratio corresponding to the first energy transition value corresponds to the second number generated by the second function.

13. The wireless communication device of claim 11, included within a user equipment (UE).

14. The wireless communication device of claim 11, included within a wireless base station (BS).

15. The wireless communication device of claim 11, wherein the first sequence corresponds to a binary expansion of the plurality of information bits, and wherein the first sequence corresponds to a final subinterval of the plurality of iterations.

16. The wireless communication device of claim 11, wherein a medium access control (MAC) layer of the wireless communication device is configured to generate the plurality of information bits.

17. The wireless communication device of claim 11, wherein a physical (PHY) layer of the wireless communication device is configured to perform the encoding operation.

18. (canceled)

19. (canceled)

20. (canceled)

21. (canceled)

22. (canceled)

23. (canceled)

24. (canceled)

25. A wireless communication device configured to perform an encoding operation on a plurality (k) of information bits, the wireless communication device comprising:
means for determining a first energy of an output sequence, the first energy of the output sequence being between zero and a defined maximum energy;
means for performing a plurality of encoding iterations, each one of the encoding iterations selecting an amplitude symbol based upon a plurality of transition probabilities and constrained by a residual energy and a residual sequence length; and
means for transmitting a wireless packet to at least one receiving device based on the output sequence, wherein the output sequence is generated from the plurality of encoding iterations and has n amplitude symbols from the plurality of encoding iterations, where n is equal to a quantity of the plurality of encoding iterations, and wherein the output sequence has the first energy.

26. The wireless communication device of claim 25, wherein the means for determining the first energy of the output sequence comprises:
means for determining a first cumulative sequence quantity, wherein the first cumulative sequence quantity defines a set of all sequences having a length n and an energy equal to or less than the defined maximum energy and belonging to a same alphabet;
means for performing a first function on the plurality of information bits, the first function generating a first number within a first interval; and
means for determining that the first number corresponds to a first subset of the set of all sequences.

27. (canceled)

28. The wireless communication device of claim 25, wherein the means for performing the plurality of encoding iterations comprises:
means for, in a first iteration, selecting a first energy transition value based at least in part on a first transition probability associated with the first energy transition value;
means for reducing the first energy by an amount associated with the first energy transition value; and
means for defining a first subinterval from an interval corresponding to the first energy, the first subinterval corresponding to the first energy transition value.

29. (canceled)

30. (canceled)
